(19) United States
(12) Patent Application Publication
(10) Pub. No.: US 2026/0289655 A1
(43) Pub. Date: Sep. 24, 2026

(54) SYSTEM

(71) Applicant: SoftBank Group Corp., Tokyo (JP)

(72) Inventor: Takayoshi SHIONO, Tokyo (JP)

(73) Assignee: SoftBank Group Corp., Tokyo (JP)

(21) Appl. No.: 19/565,535

(22) Filed: Mar. 13, 2026

(30) Foreign Application Priority Data
Mar. 19, 2025 (JP) 2025-045025

(51) Int. Cl. G06Q 30/0601

(52) U.S. Cl. CPC G06Q 30/06432

(57) ABSTRACT

A system includes a processor that is configured to provide an interface for inputting preferences and body measurements of a user, generate a prompt sentence for instructing a generative AI model to propose optimal clothing based on data input by the user, input the prompt sentence into the generative AI model, and upload a generated virtual try-on image to an information sharing network.

### CROSS-REFERENCE TO RELATED APPLICATION

This application is based on and claims priority under 35 USC 119 from Japanese Patent Application No. 2025-045025 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for recommending fashion items or vehicle modification plans are generally based on fixed rule sets or simple matching algorithms, and therefore have limited ability to generate proposals that flexibly reflect diverse user preferences and detailed physical characteristics. In particular, known virtual try-on systems often require manual configuration by designers or engineers, and are not capable of automatically generating high-quality try-on images by dynamically utilizing generative AI models based on arbitrary user inputs. Furthermore, existing systems do not adequately support a workflow in which a user obtains social feedback via information sharing networks (such as social networking services) on AI-generated try-on images and uses such feedback for decision-making. In addition, there is a lack of integrated systems that allow a user to seamlessly apply similar generative AI-based proposal mechanisms both to apparel selection and to planning modifications of vehicles, based on the user's input data. As a result, users face difficulties in efficiently obtaining optimized clothing proposals and vehicle modification plans that are customized to their personal preferences and measurements, while also leveraging social feedback and AI capabilities in a unified manner.

### SUMMARY

In order to solve the above-described problems, according to one aspect of the present invention, there is provided a system comprising a processor, wherein the processor is configured to provide an interface for inputting preferences and body measurements of a user, generate a prompt sentence for instructing a generative AI model to propose optimal clothing based on data input by the user, input the prompt sentence into the generative AI model, and upload a generated virtual try-on image to an information sharing network. In one embodiment, the processor is further configured to provide an interface through which the user inputs an opinion regarding the generated virtual try-on image, and to store the input opinion in a database. Ion another embodiment, the processor is configured to generate a prompt sentence for instructing a generative AI model to propose a modification plan for a vehicle based on information input by the user, and to input the prompt sentence into the generative AI model. By thus integrating user interfaces for inputting user data, prompt generation for generative AI models, automatic upload of AI-generated try-on images to information sharing networks, storage of user opinions, and generation of vehicle modification plans using the same generative AI framework, the system enables flexible and highly personalized proposals and supports a seamless user experience that combines AI-based generation with social feedback.

The term “system” refers to an apparatus or combination of one or more devices including at least one processor configured to execute the functions described in the claims, and may further include memory, storage, communication interfaces, and input/output devices.

The term “processor” refers to any hardware component or combination of components capable of executing instructions, such as a CPU, GPU, ASIC, FPGA, microcontroller, or a distributed computing resource in a server or cloud environment.

The term “interface” refers to a hardware and/or software mechanism that enables a user to input data to, or receive data from, the system, including graphical user interfaces, command line interfaces, web pages, mobile application screens, touch panels, or voice-based interfaces.

The term “preferences” refers to information indicating likes, dislikes, or selection tendencies of a user, including but not limited to favorite colors, designs, styles, brands, categories, or price ranges.

The term “body measurements” refers to numerical or categorical data representing physical characteristics of a user, including at least one of height, weight, body shape, or specific circumferential or length measurements of body parts.

The term “prompt sentence” refers to a text string or structured textual instruction that is generated by the processor and provided as input to a generative AI model in order to cause the generative AI model to generate a specific output such as an image or a plan. The term “generative AI model” refers to an artificial intelligence model configured to generate new content, including at least images, text, or plans, based on input data such as a prompt sentence, and may include models based on machine learning, deep learning, or neural networks.

The term “optimal clothing” refers to one or more clothing items that are selected or proposed based on the user's preferences and body measurements, and that satisfy predetermined conditions such as style suitability, size appropriateness, and optionally budget or season constraints.

The term “virtual try-on image” refers to an image or set of images generated by the generative AI model, in which clothing is visually represented as being worn by a user or an avatar corresponding to the user's body measurements.

The term “information sharing network” refers to any network-based service or platform that enables multiple users to share, view, or exchange information, including social networking services, online communities, or other web-based sharing platforms.

The term “opinion” refers to data representing a user's evaluation, comment, feedback, rating, or other subjective response regarding a generated virtual try-on image.

The term “database” refers to any structured data storage system, including relational databases, NoSQL databases, key-value stores, or other persistent storage mechanisms capable of storing and retrieving user opinions or related data.

The term “vehicle” refers to any means of transportation including, but not limited to, automobiles, motorcycles, bicycles, trucks, buses, or other motorized or non-motorized transport devices.

The term “modification plan” refers to a proposal or design for changing, customizing, or enhancing a vehicle, including alterations to exterior appearance, interior layout, performance components, accessories, or other features of the vehicle.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

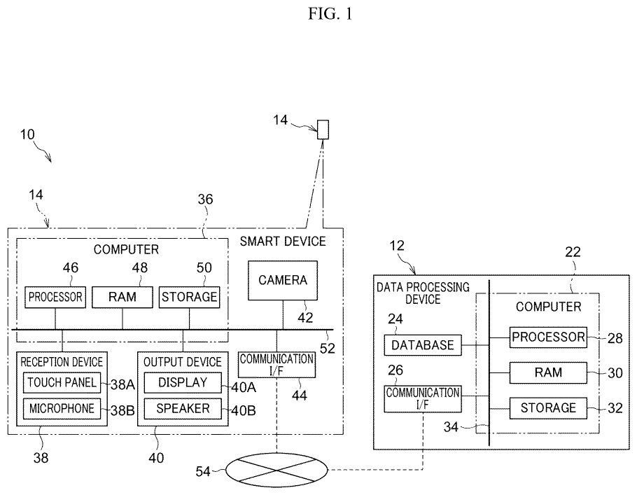

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

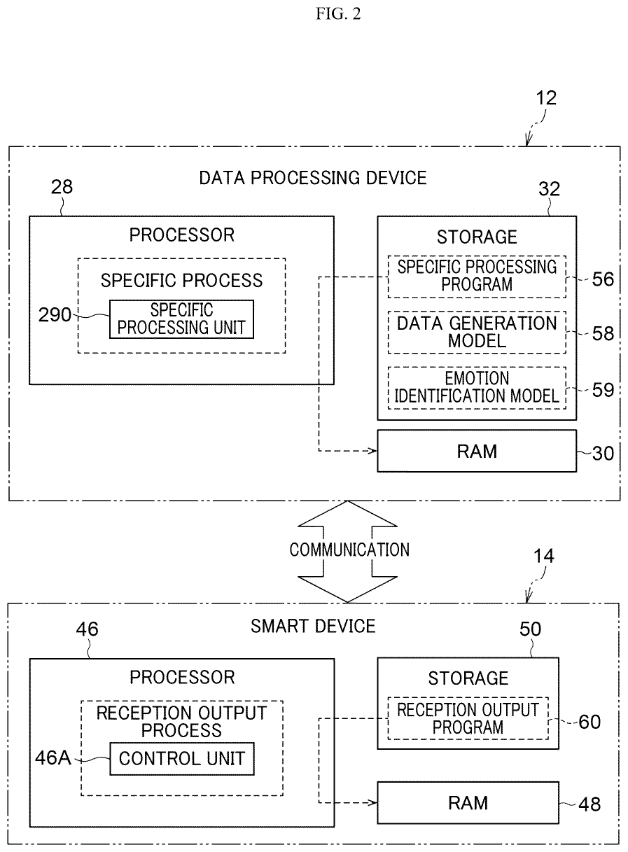

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional fashion recommendation systems typically rely on static rule-based filters or simple similarity algorithms operating on limited user attributes such as size or category. Such systems often treat the construction of prompts for generative AI models as a trivial text concatenation process, without integrating structured catalog data, past usage history, and current user constraints into a unified, machine-optimized representation. As a result, the underlying computer processing fails to efficiently narrow large product datasets, fails to produce prompts that fully leverage available structured information, and produces recommendations that are either generic or computationally wasteful.

Furthermore, in conventional architectures, user interaction data such as evaluations of try-on images and user feedback on proposed outfits are stored, if at all, in an ad hoc manner that is not tightly integrated into the data-processing pipeline that prepares inputs for a generative AI model. This leads to repeated, redundant processing of large sets of item data and user data, and it prevents the system from improving the efficiency and quality of prompt generation and recommendation over time. The absence of a structured, computer-implemented feedback loop between evaluation information, data filtering, and prompt construction results in suboptimal utilization of processing resources and network bandwidth.

In addition, when generative AI models are used both for clothing proposals and for other domains, such as vehicle modification proposals, conventional systems do not provide a unified mechanism for dynamically constructing domain-specific prompt sentences from heterogeneous structured data. This lack of a unified mechanism complicates the software architecture, increases latency, and requires separate, manually engineered pipelines for each domain, thus reducing scalability and maintainability of the computer system.

Accordingly, there is a need for an improved computer-implemented system that (i) efficiently acquires and structures user attribute information, (ii) uses dedicated numerical and tabular data processing components to narrow large catalogs into candidate sets before invoking a generative AI model, (iii) programmatically constructs rich, domain-specific prompt sentences that encode both current user attributes and past usage history, and (iv) integrates evaluation feedback into the data-processing and prompt-generation pipeline. Such a system should improve the functioning of the computer by reducing unnecessary computations for the generative AI model, by structuring data in a manner that is more suitable for automated reasoning, and by enabling reuse of historical feedback to further optimize subsequent recommendation processing.

The specific processing by the specific processing unit 290 of the data processing device 12 in Example 1 is realized by the following means.

The present invention provides a server comprising a processor configured to provide, to a terminal, an information input screen for acquiring structured user attribute information including preference information, body size information, price condition information, and season condition information, to receive the user attribute information from the terminal, to execute numerical computation logic and tabular data processing logic on stored catalog information in order to extract and sort candidate item information that satisfies the user attribute information, to generate a prompt sentence in natural language that describes, in a machine-optimized textual form, the user attribute information and the candidate item information together with past usage history information, to input the prompt sentence to a generative AI model to cause the generative AI model to generate proposal information, to associate configuration information contained in the proposal information with the candidate item information to create structured recommendation information, to transmit the structured recommendation information and associated visual try-on information to the terminal, and to receive and store evaluation information from the terminal as history information for reuse in subsequent data filtering and prompt generation. This enables the computer system to perform more efficient and targeted data reduction before invoking the generative AI model, to automatically construct richer and more informative prompt sentences from heterogeneous structured data, to reuse accumulated evaluation information as part of the computational pipeline, and thereby to improve the overall processing efficiency, recommendation relevance, and scalability of the server-side information processing architecture.

The term “processor” refers to a hardware or virtual computation unit, such as a central processing unit, graphics processing unit, or execution core in a virtual machine, that executes machine-readable instructions to perform the functions described in the present disclosure.

The term “terminal” refers to an information processing apparatus operated by a user, such as a smartphone, tablet, personal computer, or other client device, that presents user interfaces, receives user inputs, and communicates with the server over a communication network.

The term “information input screen” refers to a graphical user interface or other input interface presented on the terminal, including one or more input components such as text fields, selection boxes, sliders, or buttons, that enables a user to input or select information required by the system.

The term “preference information” refers to information indicating a user's subjective choices or likes, including but not limited to preferred colors, styles, designs, categories, and other attribute values relating to items to be recommended.

The term “body size information” refers to information indicating a physical size or dimension of a user, including but not limited to height, weight, body measurements, or standardized size indicators used for fitting items such as clothing.

The term “price condition information” refers to information specifying a monetary constraint or budget condition, including but not limited to maximum price per item, total budget, or preferred price range for recommended items.

The term “season condition information” refers to information indicating an environmental or temporal condition associated with a time period, including but not limited to season types such as spring, summer, autumn, or winter, or equivalent season-related categories.

The term “user attribute information” refers to structured information associated with a user, including at least preference information, body size information, price condition information, and season condition information, and optionally further including identifiers, demographic data, or other attributes used by the system.

The term “stored information” refers to information stored in at least one storage device accessible by the processor, including catalog information, user attribute information, history information, and any metadata used for recommendation processing.

The term “clothing item information” refers to structured catalog information related to clothing items, including but not limited to identifiers, names, categories, colors, sizes, styles, prices, season tags, and any additional attributes usable for filtering and recommendation.

The term “numerical computation program” refers to a software component or library configured to perform arithmetic operations, statistical calculations, or vector and matrix operations on numerical data for purposes such as scoring, similarity computation, or ranking.

The term “tabular data processing program” refers to a software component or library configured to operate on data represented in table form, including but not limited to performing filtering, sorting, grouping, aggregation, and transformation on records composed of multiple fields.

The term “candidate clothing information” refers to a subset of clothing item information selected and optionally sorted based on the user attribute information and the stored information, which subset is deemed suitable as candidates for recommendation.

The term “past usage history information” refers to information derived from previous interactions between the user and the system, including but not limited to viewed items, selected items, purchased items, evaluation information, and timestamps, which is used to refine recommendations.

The term “prompt sentence” refers to a textual instruction or query expressed in natural language and constructed by the processor, which encodes at least the user attribute information and candidate item information and is provided as input to a generative AI model to obtain proposal information.

The term “generative AI model” refers to a machine-learned model, such as a language model or multimodal generative model, configured to receive a prompt sentence and automatically generate output information, including but not limited to recommendations, descriptions, or structured proposals.

The term “clothing proposal information” refers to information generated by the generative AI model in response to a prompt sentence, including one or more recommended clothing configurations, item combinations, or styling suggestions, and optionally including explanatory text.

The term “clothing configuration information” refers to structured information within the clothing proposal information that identifies specific items or item types and their relationships, such as combinations of tops, bottoms, outerwear, and accessories forming an outfit.

The term “structured recommendation information” refers to data created by associating the clothing configuration information from the clothing proposal information with corresponding candidate clothing information, resulting in a machine-readable representation of recommended outfits or item sets.

The term “try-on visual display information” refers to visual data, including images, video, or rendered graphics, that represent a simulated or approximate appearance of clothing items as worn by a user or on a model, and that is generated on the basis of clothing configuration information.

The term “information sharing communication network” refers to a communication infrastructure, such as a public or private data network, that allows transmission and sharing of digital information, including but not limited to the Internet or an equivalent packet-switched network.

The term “evaluation input screen” refers to a graphical user interface presented on the terminal that enables a user to input evaluation information, such as ratings, comments, or selection of options, regarding clothing proposal information and try-on visual display information.

The term “evaluation information” refers to information indicating a user's assessment, feedback, or reaction to proposed items or visual displays, including but not limited to preference ratings, textual comments, selection choices, or rejection indications.

The term “history information” refers to stored information representing accumulated past events or interactions, including evaluation information, selection logs, or other user actions, which is used as a data source for subsequent processing.

The term “storage device” refers to any non-transitory computer-readable medium or hardware storage apparatus, such as a magnetic disk, solid-state memory, or network-attached storage, that retains data used by the processor.

The term “vehicle-related item information” refers to structured catalog information concerning vehicle components, accessories, or modification parts, including identifiers, categories, specifications, prices, and other attributes relevant to vehicle modification.

The term “vehicle modification proposal information” refers to information generated by the generative AI model, in response to a prompt sentence based on vehicle-related item information, that describes one or more modification plans, configurations, or upgrade suggestions for a vehicle.

In one embodiment, a server operates as a centralized information processing system that cooperates with multiple terminals operated by users. The server includes at least one processor, a main memory, a non-transitory storage device, and a network interface. The processor executes an operating system such as a general-purpose server operating system and application software implemented, for example, using a general-purpose programming language runtime. The storage device stores catalog information including clothing item information and optionally vehicle-related item information, user attribute information, history information, and trained parameters of a generative AI model or an interface specification for accessing such a model.

A terminal operates as a client device that presents user interfaces and exchanges messages with the server via a communication network, such as a packet-switched network. The terminal may be implemented as a smartphone, tablet, or personal computer. The terminal includes a display, an input unit (for example, a touchscreen or pointing device), a local processor, and a communication unit for performing secure communication with the server. The server provides to the terminal an information input screen that enables a user to input preference information, body size information, price condition information, and season condition information. The terminal displays this information input screen as a graphical user interface that may include, for example, text input fields for body size information, selection lists for preferred styles, color pickers for preference information, sliders for price ranges, and selection buttons for seasons. The terminal collects the values input by the user and converts the values into a structured user attribute information record, such as a key-value-based in-memory structure, and transmits this record to the server through a request formatted according to an application-layer protocol.

The server receives the user attribute information and stores it in a structured data storage, such as a relational table or key-value store. The server associates the user attribute information with a user identifier so that the server can later correlate the information with past usage history information. The server then accesses stored information including clothing item information. The clothing item information is stored as records including attributes such as item identifier, category, size range, colors, style tags, price values, and season tags. The server reads the clothing item information into a tabular data structure, such as an in-memory table whose columns correspond to attributes and whose rows correspond to items.

The server applies a numerical computation program and a tabular data processing program to the tabular data structure. For example, the server uses a numerical computation library to convert attribute values into numerical feature vectors. The server may map categorical attributes, such as colors or styles, into one-hot or embedded vectors, convert price values into normalized scalar values, and represent size ranges and season tags as numerical indicators. The server uses a tabular data processing program to perform column-based filtering operations. In particular, the server filters the clothing item information according to size constraints derived from the body size information, filters the clothing item information to remove items whose price exceeds the price condition information, filters by colors and styles matching the preference information, and filters by season tags that correspond to the season condition information. The server may then compute a relevance score using a numerical computation algorithm that calculates, for each item, a similarity measure between an item feature vector and a user preference feature vector derived from past usage history information. The server sorts the filtered clothing item information according to this relevance score to obtain candidate clothing information that is optimized both for fit and preference.

By performing the above operations using vectorized numerical routines and column-based tabular filters, the server reduces the number of records that need to be processed in later stages and reduces memory access operations. This leads to lower execution time and lower power consumption compared to a naive approach that would repeatedly query an entire catalog or call a generative AI model without pre-filtering.

The server also maintains past usage history information, such as viewing logs, selection logs, purchase records, and evaluation information submitted by the user. The server stores such history information in one or more tables keyed by user identifier and timestamp. The server periodically aggregates this history information using the numerical computation program and the tabular data processing program. For example, the server counts frequencies of selected colors, categories, or styles; computes average prices of purchased items; and builds a user preference vector that models the propensity of the user to choose certain attributes. The server uses statistical methods such as weighted averages or exponential decay functions so that more recent interactions contribute more to the preference vector than older interactions. This aggregation process yields past usage history information that is structured and directly usable as input for subsequent recommendation tasks, thereby improving accuracy and reducing the need to reprocess raw logs each time.

The server generates a prompt sentence in natural language by combining user attribute information, candidate clothing information, and past usage history information. In one embodiment, the server uses a template-based natural language generation module. The server constructs the prompt sentence as a sequence of text segments, each segment representing a section such as “Current request,” “Past preferences,” and “Candidate items from catalog.” The server does not simply concatenate strings, but instead selects and arranges segments in a structured manner based on rules. For example, the server orders color-related sentences before style-related sentences when the numerical analysis indicates that color is the most influential factor for the user, as determined from the preference vector. An example of a generated prompt sentence is as follows:

“The user is looking for casual summer outfits.

Current request: prefers blue, casual style, size M, budget 10,000 yen per item, season is summer.

Past preferences: the user frequently selects blue and navy tops, relaxed-fit items, and casual styles.

Here are candidate items from the catalog:
1. Blue cotton T-shirt, casual, size M, price 3,000 yen, summer.
2. Navy polo shirt, casual, size M, price 4,500 yen, summer.
3. Light blue short-sleeve shirt, casual, size M, price 5,500 yen, summer.
4. Blue denim shorts, casual, size M, price 4,000 yen, summer.
5. White sneakers, casual, size 26 cm, price 7,000 yen, all seasons.

Using the above information, propose 3 complete outfit suggestions (top and bottom, optionally shoes) that match the user's style, size, budget, and season. For each outfit:
Specify concrete items from the candidate list.
Explain why the combination matches the user's preferences and past choices.
Keep each explanation within 3-4 sentences.”

As another example, the server may construct a prompt sentence oriented toward a different user:

“The user prefers elegant and feminine styles, likes pastel colors (especially pink and beige), and wants outfits for spring. The user's body size corresponds to size S. The total budget for a full outfit (top and bottom) is within 15,000 yen.

Here are candidate items from the catalog:
1. Light pink blouse, elegant, size S, price 6,000 yen, spring.
2. Beige pleated skirt, elegant, size S, price 7,000 yen, spring.
3. White lightweight cardigan, elegant, size S, price 5,500 yen, spring.

Based on the user's preferences and these candidates, propose 3 coordinated outfits appropriate for spring weather. Explain why each suggestion matches the user's preferences and constraints.”

The server inputs the prompt sentence to a generative AI model. In one embodiment, the generative AI model is implemented as a deep neural network including an embedding layer, a multi-head self-attention mechanism, multiple stacked transformer blocks, and an output decoding layer. The model parameters are pre-trained on a large corpus of text that includes descriptions of clothing, styles, and outfits, and may be fine-tuned on domain-specific data consisting of annotated outfit recommendations and user feedback. During training, the model minimizes a loss function, such as a cross-entropy loss, defined over predicted tokens and ground-truth tokens. The server performs training or fine-tuning by repeatedly computing the loss, propagating gradients backward through the network, and updating weights by an optimization algorithm such as stochastic gradient descent with momentum or an adaptive gradient method. The server may apply regularization techniques such as dropout, weight decay, or data augmentation (for example, synonym replacement in textual descriptions) to improve generalization and reduce overfitting.

At runtime, the server tokenizes the prompt sentence using a predetermined tokenizer and converts the tokens into embedding vectors. The generative AI model computes representations through multiple layers of self-attention and feed-forward transformations, resulting in output probability distributions for subsequent tokens. The server applies decoding strategies such as greedy decoding, beam search, or top-p sampling to generate clothing proposal information that includes item combinations and associated explanations. Because the prompt sentence already encodes pre-filtered candidate clothing information and a compact representation of user preferences, the generative AI model does not need to perform large-scale retrieval internally; instead, the model focuses on combinatorial reasoning and explanation generation. This significantly reduces model compute cost, improves response latency, and decreases the volume of prompt tokens compared to naive approaches that would include the full catalog or unprocessed raw logs in the prompt. The server parses the clothing proposal information generated by the generative AI model. The proposal information typically includes references to candidate items, such as “Blue cotton T-shirt” or numeric identifiers corresponding to the numbered list in the prompt sentence. The server uses matching logic to associate these references with corresponding records in the candidate clothing information. For example, the server may use string matching and identifier-based mapping to resolve each proposed item to a specific item identifier. The server then constructs structured recommendation information representing each outfit as a tuple of item identifiers and associated metadata, along with an explanation text segment. This structured recommendation information reduces ambiguity and enables efficient downstream processing, such as caching, indexing, and analytics.

The server generates try-on visual display information based on the clothing configuration information included in the structured recommendation information. In one embodiment, the server uses a rendering engine or an external image synthesis service to create composite images that overlay item images on a virtual mannequin or a body model approximating the user's body size information. The server selects base body models from a library on the basis of body size information and applies geometric transformations such as scaling and warping to align item images with body contours. The server may use additional neural network models, for example convolutional neural networks for segmentation and blending, to improve the realism of the try-on visual display information. By performing these operations on the server side, the system can pre-compute optimized visual data and reduce the computational load on terminals.

The server transmits the structured recommendation information, the clothing proposal information, and the try-on visual display information to the terminal. The terminal displays the recommended outfits in a dedicated screen that lists outfits, shows thumbnails of try-on images, and displays textual explanations. The user views the outfits and may enter evaluation information, for example, rating an outfit on a scale, selecting whether they like or dislike specific items, or entering textual comments. The terminal collects this evaluation information via an evaluation input screen and sends the evaluation information back to the server.

The server stores the evaluation information as history information in the storage device and incorporates it into the past usage history information. The server may represent evaluation information as numerical scores and update user preference vectors by applying weighting functions that account for the strength and recency of evaluations. For example, when the user repeatedly gives high ratings to outfits that include certain colors or styles, the server increases the weights of corresponding dimensions in the user preference vector. This updated vector then affects subsequent candidate clothing information extraction and prompt sentence generation. As a result, the system dynamically adapts to the user's evolving taste without manual intervention. From a technical perspective, this feedback loop reduces the number of irrelevant items that pass through the computation pipeline, thereby lowering the average compute cost per recommendation and increasing the hit rate of relevant recommendations.

In another embodiment, the server uses a similar architecture to generate vehicle modification proposal information. In this case, the stored information includes vehicle-related item information such as parts, accessories, and configurations. The server receives user attribute information that may include vehicle type, performance goals, budget, and aesthetic preferences. The server filters vehicle-related item information using the numerical computation program and the tabular data processing program to obtain candidate vehicle-related items, constructs a domain-specific prompt sentence that describes the current request, past usage history information for vehicle-related decisions, and candidate vehicle-related items, and inputs the prompt sentence to a generative AI model. The generative AI model, which may share the same architecture but be fine-tuned on vehicle-related text, outputs vehicle modification proposal information describing recommended combinations of parts and configurations. The server then associates the proposal information with the candidate vehicle-related item information to construct structured recommendation information for vehicle modifications. In this embodiment, the system can control the selection of hardware components to be installed in a physical vehicle, and by pre-filtering and structuring recommendations in the manner described, it reduces the risk of incompatible or suboptimal configurations.

The system as described improves computer technology in several ways. First, the server performs hierarchical data reduction by combining numerical feature computation, vector-based similarity, and table-based filtering before invoking a generative AI model. This reduces the size of the data that must be encoded into the prompt sentence and processed by the model, thereby reducing processing time and memory usage. Second, the server uses a structured prompt generation mechanism that embeds both current and historical user data in a machine-optimized, domain-specific textual format, which improves the quality and stability of the generative AI model output compared to ad hoc prompt construction. Third, the server closes the loop between evaluation information and recommendation generation by converting feedback into numerical updates of preference vectors, which in turn directly influence subsequent data filtering and prompt design. This reduces the number of iterations required to converge to a configuration that the user finds acceptable and minimizes unnecessary communication and computation. Fourth, by mapping candidate items and proposal outputs into structured recommendation information, the server enables efficient indexing, caching, and reuse across multiple sessions and users, further reducing the overall load on the generative AI model.

In addition, the system employs non-conventional processing flows that differ from manual human operations. A human stylist or designer does not typically compute high-dimensional feature vectors, apply vector similarity algorithms, and dynamically adjust prompt sentences based on numerical feedback loops. The server, by contrast, implements specific algorithms and data structures to achieve these functions, resulting in improved computational efficiency, reduced latency, and enhanced scalability when processing large catalogs and many concurrent user sessions. As a consequence, the system represents more than a mere automation of human mental steps; it embodies a technical improvement to the way computer systems manage, process, and utilize large-scale structured and unstructured data in combination with a generative AI model.

Alternative embodiments may modify or extend the described configuration. For instance, the server may use different neural network architectures, such as encoder-decoder networks with attention or recurrent neural networks, instead of transformer-based models, while still employing the same concept of pre-filtering and structured prompt generation. The numerical computation program and tabular data processing program may be implemented using different software frameworks or may execute on dedicated hardware accelerators. The terminal may offload part of the pre-processing or visualization computations, such as rendering try-on images locally, while the server continues to perform core data filtering and prompt sentence generation. Furthermore, the same architecture can be extended to domains other than clothing and vehicle modification, by replacing the stored information and domain-specific attributes while retaining the system's hierarchical data processing, structured prompt generation, and feedback integration mechanisms.

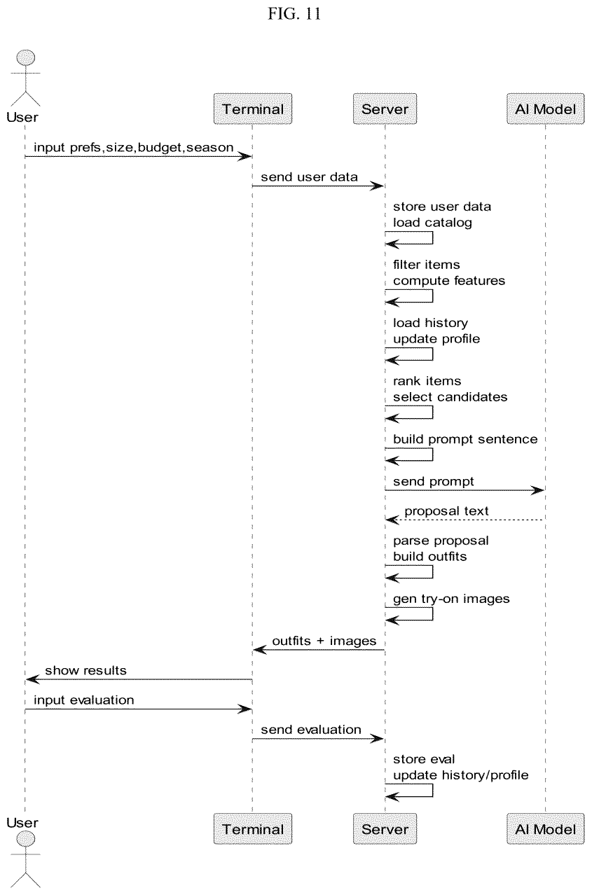

The following describes the processing flow using FIG. 11.

### Step 1:

The terminal displays an information input screen to the user.

The terminal renders input components such as text fields for body size information, dropdown lists for style categories, color selectors for preference information, sliders for price condition information, and buttons for season condition information.

The user operates the terminal to input values for preferred colors, preferred styles, body size (for example, height and standardized size), maximum price per item, and target season.

The terminal validates the input values locally, for example by checking that numeric fields contain numbers and that required fields are not empty.

Input: User actions and raw keystrokes or selection events.

Processing: The terminal converts the raw input events into a structured record, for example a local key-value mapping such as {preferred_colors, style, body_size, max_price, season}.

Output: User attribute information in a structured format held in the terminal's memory.

### Step 2:

The terminal transmits the user attribute information to the server.

The terminal encapsulates the user attribute information into a request message and attaches a user identifier if available.

The terminal sends the message to the server via a secure communication protocol over a communication network.

The terminal may display a loading indicator while waiting for a response.

Input: Structured user attribute information and user identifier.

Processing: The terminal serializes the structured information into a transmission format and attaches protocol headers required by the transport and application layers.

Output: A network request containing the serialized user attribute information delivered to the server.

### Step 3:

The server receives and parses the user attribute information.

The server accepts the incoming network request via a network interface and forwards the request to an application program executed by the processor.

The server deserializes the request body to reconstruct the structured user attribute information.

The server verifies that each field satisfies predetermined constraints, such as allowable ranges for body size and non-negative values for price.

Input: Serialized user attribute information and associated headers.

Processing: The server decodes the message, checks field types and ranges, and maps fields into an internal data structure, such as an object or record representing user attribute information.

Output: Validated user attribute information stored in server memory.

### Step 4:

The server stores the user attribute information and retrieves catalog data.

The server writes the user attribute information into one or more records in a data storage structure, associating the information with a user identifier and timestamp.

The server issues a database query or equivalent storage access to retrieve clothing item information from a catalog table that stores attributes such as item identifiers, categories, colors, style tags, size ranges, prices, and season tags.

Input: Validated user attribute information and storage access parameters.

Processing: The server executes database insert or update operations for the user attribute information and select operations for the clothing item information.

Output: Persistent records representing the user attribute information and an in-memory collection of clothing item records.

### Step 5:

The server constructs a tabular data structure and transforms item attributes into numerical features.

The server loads the clothing item records into a tabular data structure, such as an in-memory table with columns for color, style, size range, price, and season tag.

The server applies a numerical computation program to convert categorical attributes into numerical feature representations, such as one-hot vectors or embedded indices, and to normalize price values into a numerical scale.

The server also encodes season tags and size ranges as numerical indicators to facilitate later filtering and similarity computations.

Input: Collection of clothing item records with categorical and numeric attributes.

Processing: The server iterates over each record, maps categorical fields to indices or vectors using pre-defined dictionaries or embedding matrices, normalizes numeric fields, and stores the transformed values in additional columns or feature arrays.

Output: A feature-augmented tabular data structure representing clothing item information in both symbolic and numerical form.

### Step 6:

The server filters clothing items to generate candidate clothing information.

The server applies sequential filters to the tabular data structure according to body size, price, color, style, and season constraints derived from the user attribute information.

The server first filters to items whose size ranges are compatible with the user's body size, then filters out items exceeding the maximum price, and then filters by preferred colors and preferred styles.

The server finally filters by season, keeping only items tagged as appropriate for the specified season.

Input: Feature-augmented tabular data structure and user attribute information (body size, price condition, colors, styles, season).

Processing: The server executes column-based comparison operations and logical conjunctions to remove rows that do not satisfy the constraints, thereby narrowing the table to items matching the user's basic requirements.

Output: Candidate clothing information as a reduced tabular dataset containing only matching item records.

### Step 7:

The server retrieves and aggregates past usage history information.

The server queries storage structures that hold history information such as viewed items, selected items, purchased items, and previous evaluation information for the same user.

The server aggregates these records to compute statistics, such as the frequency of colors, styles, and categories chosen by the user, and average price levels.

The server transforms these statistics into a numerical user preference vector and textual summary phrases.

Input: History records keyed by user identifier and timestamps.

Processing: The server counts occurrences, computes weighted averages based on recency, and normalizes frequencies to form a multi-dimensional preference vector; in parallel, the server maps high-weight dimensions to human-readable summary statements.

Output: A numerical user preference vector and past usage history information expressed as natural-language summary strings.

### Step 8:

The server computes relevance scores for candidate items.

The server uses the numerical computation program to compute, for each row in the candidate clothing information, a similarity measure between the item feature vector and the user preference vector.

The server may apply a cosine similarity, dot product, or another distance metric to generate a scalar relevance score for each item.

The server sorts the candidate items in descending order of relevance score to prioritize items aligned with historical preferences.

Input: Candidate clothing feature vectors and user preference vector.

Processing: The server computes vector operations item-by-item to obtain similarity scores, then executes a sorting algorithm based on these scores.

Output: Ranked candidate clothing information with associated relevance scores.

### Step 9:

The server selects a subset of candidate items for inclusion in a prompt sentence.

The server chooses a fixed or adaptive number of top-ranked items, for example the top 5 or top 20 items, from the ranked candidate clothing information.

The server extracts for each selected item the attributes needed to describe the item in natural language, such as color, style, size, price, and season tag.

Input: Ranked candidate clothing information with relevance scores.

Processing: The server truncates the list at a predetermined cutoff and maps each record into a simplified description object containing only relevant attributes for textual representation.

Output: A subset of candidate clothing information prepared for natural-language description.

### Step 10:

The server generates a prompt sentence for a generative AI model.

The server selects a prompt template and inserts the current request description, the natural-language summary of past preferences, and the list of selected candidate items into designated sections of the template.

The server constructs a coherent sequence of sentences and bullet lists that specify the user's current conditions, historical tendencies, and available candidates in a compact form.

Input: User attribute information, past usage history summaries, and selected candidate clothing descriptions.

Processing: The server concatenates template segments and dynamically generated text fragments, orders segments based on predetermined rules, and generates a single natural-language prompt string.

Output: A prompt sentence containing structured, domain-specific information ready for input to the generative AI model.

### Step 11:

The server encodes the prompt sentence and executes inference on the generative AI model.

The server tokenizes the prompt sentence using a predetermined vocabulary and converts tokens into embedding vectors.

The server processes the embeddings through the layers of a neural network model, including multiple attention layers and feed-forward layers, to compute probability distributions for output tokens.

The server executes a decoding strategy, such as beam search, to generate the most likely sequence of tokens that constitute clothing proposal information.

Input: Prompt sentence as a text string.

Processing: The server performs tokenization, embedding lookup, matrix multiplications, attention weight computations, activation function applications, and decoding logic to transform the prompt into an output text sequence.

Output: Clothing proposal information expressed as generated text that describes outfit combinations and explanations.

### Step 12:

The server parses the generated clothing proposal information and constructs structured recommendation information.

The server analyzes the generated text to identify references to specific candidate items, such as references to numbered items in the prompt or item attributes like “Blue cotton T-shirt, size M.”

The server matches these references against the selected candidate clothing information using pattern matching and identifier mapping.

The server creates structured records representing each recommended outfit as a combination of item identifiers and attaches the corresponding explanation text segments.

Input: Generated clothing proposal text and selected candidate clothing information.

Processing: The server performs text parsing, string matching, and mapping operations to align textual references with internal identifiers and aggregates related items into outfit-level records.

Output: Structured recommendation information that machine-represents outfits and associated explanations.

### Step 13:

The server generates try-on visual display information for each recommended outfit.

The server selects or constructs a body model based on the user's body size information and selects corresponding item images or renderable item models from storage.

The server applies geometric transformations and compositing operations to overlay item graphics onto the body model, and optionally uses an image-processing neural network to refine edges and shading.

Input: Structured recommendation information and body size information, along with stored item images or 3D models.

Processing: The server calculates scale factors from body size parameters, transforms item images accordingly, blends item images with the body model, and encodes the resulting composite into image or video files.

Output: Try-on visual display information representing the recommended outfits on a body approximation.

### Step 14:

The server transmits recommendation results to the terminal.

The server packages the structured recommendation information, clothing proposal text, and try-on visual display information into a response message.

The server sends the response to the terminal using the same or a compatible communication protocol.

Input: Structured recommendation information, clothing proposal text, and try-on visual display information.

Processing: The server serializes the data into a response structure and attaches appropriate protocol headers.

Output: A response message delivered to the terminal containing recommendation results.

### Step 15:

The terminal displays the recommendation results to the user.

The terminal decodes the response and renders a visual layout showing outfit lists, thumbnails of try-on images, and textual explanations.

The terminal allows the user to scroll through outfits, open detailed views, and interact with items, for example by tapping on an item to see more information.

Input: Response message from the server containing structured recommendation information and visual assets.

Processing: The terminal parses the message, creates in-memory representations of outfits and images, and executes rendering operations on the display.

Output: A user interface presenting recommended outfits and associated try-on visual display information.

### Step 16:

The user evaluates the recommendations via the terminal.

The user views the displayed outfits and try-on images and interacts with evaluation controls, such as rating scales, like/dislike buttons, or comment fields.

The terminal records the user's selections and textual input as evaluation information.

Input: Visual and textual output displayed on the terminal and user interactions.

Processing: The terminal converts the user's evaluation actions into structured evaluation records with fields such as outfit identifier, rating value, and comment text.

Output: Evaluation information stored temporarily in the terminal's memory.

### Step 17:

The terminal transmits the evaluation information to the server.

The terminal bundles one or more evaluation records into a message addressed to the server.

The terminal sends this message over the communication network, optionally batching multiple evaluations to reduce overhead.

Input: Structured evaluation information generated from user interactions.

Processing: The terminal serializes the evaluation records, schedules transmission, and attaches user identifiers to allow association with existing records.

Output: A network message containing evaluation information delivered to the server.

### Step 18:

The server updates history information and preference vectors based on evaluation information.

The server receives and parses the evaluation message, then writes the evaluation information into storage structures as new history records.

The server recalculates or incrementally updates the user preference vector by applying weighting rules that emphasize positively evaluated items and de-emphasize negatively evaluated items.

The server adjusts frequency counts and preference scores for attributes such as colors, styles, and categories based on the evaluation signals.

Input: Received evaluation information and existing user preference vector and history information.

Processing: The server inserts evaluation records into history tables, recomputes statistics and preference weights using numerical operations, and updates the stored user preference vector.

Output: Updated history information and an updated user preference vector that will influence subsequent candidate item filtering and prompt sentence generation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional online fashion recommendation and virtual try-on systems generally rely on fixed, heuristic rule sets or static recommendation engines that process user preferences and body dimensions in isolation from natural-language context. In such systems, a server typically receives numerical body measurements and categorical preference fields, performs predetermined filtering and ranking of catalog items, and then renders generic images or size overlays. This architecture suffers from several technical limitations. First, the processing pipeline does not exploit a dynamically generated, semantically rich prompt sentence that expresses a user's constraints and style intentions in natural language. As a result, the system fails to fully utilize advances in generative AI models for capturing nuanced preferences, and cannot flexibly adapt the recommendation logic without manual reprogramming. This leads to inefficient utilization of computing resources and reduced accuracy in the selection of garments that fit both the user's style and body dimensions. Second, conventional systems often treat virtual try-on rendering as a separate, downstream graphics task that is loosely coupled to the recommendation logic. The selection of garments and the generation of three-dimensional try-on data are not coordinated through a unified data representation that ties prompt-driven semantic features, body-dimension features, and three-dimensional garment shape information together. This separation can lead to redundant computations, inconsistent data flows, and increased latency when rendering a personalized three-dimensional body model wearing selected garments.

Third, prior systems do not effectively integrate user feedback on virtual try-on results into the core computational pipeline. Evaluation information and preference-change information entered by the user are typically stored for marketing or analytics purposes, without being systematically fed back to update the generative prompt formation and the subsequent selection of garment candidates. Consequently, the system is slow to adapt to evolving user preferences, wasting processing cycles on generating and rendering unsuitable items, and providing a degraded overall computational efficiency.

Fourth, existing solutions lack a generalized mechanism in which the same generative AI-based prompt-generation and inference pipeline can be extended beyond garments to other objects, such as personalizable products or modifiable structures. Without a generalized, prompt-driven specification and modification workflow at the server, it is difficult to reuse the computational architecture for new application domains, resulting in fragmented implementations and unnecessary duplication of software modules.

Accordingly, there is a need for an improved computer-implemented system that: (i) uses a generative AI model to generate a structured prompt sentence in natural language based on user preference information and body dimension information; (ii) uses this prompt sentence, together with structured user data, to drive a trained inference model that selects garment candidates and outputs both attribute information and three-dimensional shape information; (iii) tightly integrates the selection results with three-dimensional body modeling and garment-fitting rendering pipelines; and (iv) incorporates user evaluation and preference-change information back into the prompt-generation and selection processes. Such a system should improve the technical operation of the server and associated devices by reducing redundant computations, improving data flow coherence, and enabling more accurate and efficient generation of virtual try-on images and three-dimensional scene data.

The specific processing by the specific processing unit 290 of the data processing device 12 in Application Example 1 is realized by the following means.

The present invention provides a server comprising a processor, a storage device, and a communication interface, the processor being configured to receive, via the communication interface, preference information and body dimension information of a user from a user device, generate, based on structured information including the preference information and the body dimension information, a prompt sentence expressed in natural language by executing character-string generation processing using a generative AI model, input the prompt sentence and the structured information to a trained inference model to execute feature-extraction processing and similarity-calculation processing so as to select garment candidates from a garment information set and output attribute information and three-dimensional shape information of the garment candidates, generate or deform a three-dimensional body model of the user based on the body dimension information, superimpose the garment candidates on the three-dimensional body model based on the three-dimensional shape information by executing three-dimensional rendering processing and shape-fitting processing to generate a virtual try-on image or virtual try-on three-dimensional scene data, transmit, via the communication interface, the virtual try-on image or the virtual try-on three-dimensional scene data to the user device for display and upload the virtual try-on image or the virtual try-on three-dimensional scene data to an information-sharing communication network, and execute, based on merchandise identification information associated with the garment candidates and the virtual try-on image or the virtual try-on three-dimensional scene data, a purchase process in cooperation with a transaction processing apparatus upon receiving a purchase request. This enables the computing system to integrate generative AI-based prompt formation, trained inference-based candidate selection, and three-dimensional rendering into a unified, feedback-aware pipeline that improves recommendation accuracy, reduces unnecessary rendering and data transfer, and enhances overall computational efficiency and responsiveness in virtual try-on and related modification-planning applications.

The term “user device” refers to an electronic apparatus including at least a display apparatus and an input apparatus, and configured to transmit user-related information to, and receive information from, a server via a communication network.

The term “display apparatus” refers to a hardware component configured to visually present information, such as images, text, or three-dimensional scenes, to a user.

The term “input apparatus” refers to a hardware component configured to receive input operations from a user, such as touch input, keyboard input, pointing input, voice input, or gesture input.

The term “preference information” refers to information indicating subjective choices or tendencies of a user, including at least one of desired colors, styles, categories, seasons, price ranges, or usage scenes related to items.

The term “body dimension information” refers to measurement information representing physical dimensions of a user's body, including at least one of height, width, circumference, length, or proportional values of body parts.

The term “structured information” refers to information in which multiple items of data, including preference information and body dimension information, are organized according to a predetermined schema or data format so as to be machine-readable and processable.

The term “prompt sentence” refers to a text string expressed in natural language that describes an instruction or request for a computational model, and that is generated based on structured information to specify conditions for proposing candidates related to an object.

The term “generative AI model” refers to a machine-learned information processing model configured to generate data such as text, images, or other content, and in the present context is configured to generate a prompt sentence by performing character-string generation processing based on input information.

The term “trained inference model” refers to a machine-learned model that has been trained on training data in advance and that is configured to perform inference processing, including at least feature-extraction processing and similarity-calculation processing, in response to input data.

The term “feature-extraction processing” refers to processing in which the trained inference model transforms input data into internal representations or feature values suitable for subsequent similarity calculation or classification.

The term “similarity-calculation processing” refers to processing in which similarity or distance between features of different data items is computed according to a predetermined metric, such as a cosine similarity or Euclidean distance.

The term “garment information set” refers to a collection of data items representing multiple garments, each data item including at least attribute information and, in some cases, three-dimensional shape information associated with a garment.

The term “garment candidates” refers to one or more garments selected from the garment information set based on processing by the trained inference model, in accordance with the prompt sentence and the structured information.

The term “attribute information” refers to descriptive information associated with an item, including at least one of type, category, color, size, material, season, or price.

The term “three-dimensional shape information” refers to data representing the three-dimensional geometry of an object, including at least one of mesh data, vertex coordinates, polygon definitions, skeleton structures, or deformation parameters.

The term “three-dimensional body model” refers to a three-dimensional geometric representation of a user's body, including at least mesh data, skeleton data, or parameter values, and configured to be used for virtual try-on rendering.

The term “three-dimensional rendering processing” refers to processing for generating image data or scene data by applying projection, shading, lighting, and other graphical operations to three-dimensional shape information.

The term “shape-fitting processing” refers to processing in which a three-dimensional shape of an item is adjusted or deformed to conform to another three-dimensional shape, such as fitting a garment model to a three-dimensional body model.

The term “virtual try-on image” refers to image data generated by three-dimensional rendering processing, in which a representation of a user, based on a three-dimensional body model, is depicted wearing one or more selected items.

The term “virtual try-on three-dimensional scene data” refers to data representing a three-dimensional scene that includes at least a three-dimensional body model and one or more garment candidates, and that is configured to be rendered or interactively displayed by a client device.

The term “communication interface” refers to hardware and software components that enable data communication between the server and external devices or networks using communication protocols.

The term “information-sharing communication network” refers to a communication network or service that enables distribution or sharing of digital content, such as images or three-dimensional data, among multiple users or devices.

The term “merchandise identification information” refers to information that uniquely or specifically identifies an item, including at least one of a product identifier, catalog code, or link information used for referencing the item.

The term “purchase request” refers to a message or operation transmitted from a user device to the server, indicating an intention to purchase a specified item associated with merchandise identification information.

The term “transaction processing apparatus” refers to an apparatus or system configured to execute at least part of a commercial transaction, including processing such as order registration, payment processing, or settlement.

The term “storage device” refers to a hardware component or subsystem, such as a memory or a non-volatile storage medium, configured to store programs, models, user data, or intermediate processing results.

The term “evaluation information” refers to information indicating a user's assessment of a virtual try-on image or virtual try-on three-dimensional scene data, including at least one of ratings, selections, approval indications, or rejection indications.

The term “preference-change information” refers to information indicating a modification of existing preference information by the user, including changes to desired colors, styles, budgets, or other preference parameters.

The term “object” refers to any item or subject of processing other than the user's body itself, including at least garments, equipment, vehicles, personalizable products, or modifiable structures.

The term “specification information” refers to information that describes characteristics, configuration, or constraints of an object to be processed or modified.

The term “modification-desire information” refers to information indicating a user's desired changes, improvements, or customization requests for an object.

The term “modification plan” refers to information representing a proposed change or configuration of an object, generated by processing a prompt sentence and structured information using a generative AI model or a trained inference model.

In one embodiment, a server cooperates with at least one terminal to implement a fashion recommendation and virtual try-on system. The server includes a processor, a storage device, and a communication interface. The terminal includes a display apparatus, an input apparatus, a communication module, and a graphics processing unit. The user operates the terminal to provide input information and to view virtual try-on results.

The terminal displays an input user interface that is implemented, for example, as a native application running on a mobile operating system. The terminal uses the display apparatus to present input widgets such as text fields, selection lists, sliders, and buttons that allow the user to specify preference information and body dimension information. The terminal uses the input apparatus, such as a touch panel, microphone, or keyboard, to acquire the user's operations and converts the acquired operations into digital input events handled by an application framework.

The terminal converts the acquired preference information and body dimension information into a structured data record. The terminal may represent the structured data record as a key-value map containing, for example, a color field, a style field, a budget field, a season field, and multiple numeric fields for body dimensions such as height, chest circumference, waist circumference, and hip circumference. The terminal then transmits this structured data record to the server via the communication interface, using a network protocol stack and an encrypted transport protocol.

The server receives the structured data record and stores it in the storage device. The server uses a data-management component to map the received data into an internal data structure such as a normalized table or an in-memory object graph. The server may, for example, convert free-text style descriptions into controlled vocabulary codes, quantize budget ranges into numeric intervals, and normalize body measurements into a predetermined unit system.

The server writes both the raw and normalized data into a relational data store or a document store.

The server generates a prompt sentence by executing a generative AI model implemented as a neural network. In one embodiment, the generative AI model comprises a transformer-based sequence-to-sequence architecture including an encoder and a decoder. The server uses the structured data record as input to the encoder. The server first converts each categorical field such as preferred color or style into a token sequence and converts each numeric field such as height or waist into discretized or embedded representations. The server concatenates these token sequences according to a predefined template, such as “Color=blue; Style=casual; Season=spring; Budget=under 100; Height=170 cm; Waist=75 cm,” and then supplies the resulting sequence into an embedding layer of the neural network.

The generative AI model uses multiple self-attention layers, feed-forward layers, and normalization layers to compute a latent representation of the input context. The decoder of the generative AI model then generates, token by token, a natural-language string representing the prompt sentence. The generative AI model uses a probability distribution over a vocabulary at each decoding step and selects the next token using a selection strategy such as beam search or top-k sampling. The server accumulates the generated tokens until an end-of-sentence token appears, and then converts the token sequence into a character string. The server thus generates a prompt sentence such as:

“The user prefers blue casual clothing suitable for spring and has a total budget under 100 USD. The user's height is 170 cm and the waist size is 75 cm. Based on these conditions, generate a list of specific tops and bottoms that match the user's style, fit the user's body size, and are appropriate for everyday wear.”

The server stores the generated prompt sentence in the storage device, associated with the corresponding user record. The server then uses the generated prompt sentence, together with the structured data record, as input to a trained inference model that is implemented as another neural network. In one embodiment, the trained inference model comprises a dual-encoder architecture. The server uses a first encoder to convert the prompt sentence into a text feature vector and uses a second encoder to convert garment descriptions in a garment information set into item feature vectors.

The server precomputes and stores the item feature vectors for all garments in the garment information set. Each garment in the garment information set has attribute information including at least category, color, size range, material, season, and price, and may additionally have a textual description and a reference to three-dimensional shape information. The server uses a text embedding network, which may be a transformer- or convolution-based text encoder, to convert the garment descriptions into fixed-length vectors.

The server stores these vectors together with their corresponding garment identifiers in an index structure.

The server converts the prompt sentence into a prompt vector using the same or a compatible text encoder. The server then calculates similarity scores between the prompt vector and each garment vector using a similarity metric, such as cosine similarity. The server further filters and adjusts the similarity scores based on numerical constraints derived from the structured data record. For example, the server discards garments whose size range does not cover the user's body dimension information, discards garments whose price exceeds the budget information, and decreases similarity scores for garments whose season or color does not match the preference information. The server may implement this adjustment as a rule-based weighting layer that multiplies or adds adjustment values to the similarity scores.

The server ranks the garments according to the adjusted similarity scores and selects a subset as garment candidates. The server retrieves, for each selected garment candidate, its attribute information and three-dimensional shape information from the storage device. The three-dimensional shape information includes at least a polygon mesh, vertex positions, texture coordinates, and optionally skeletal data for animation. The server outputs this information as an internal data structure for use by a rendering component.

The server generates or deforms a three-dimensional body model representing the user. In one embodiment, the server maintains a parametric human-body template model defined by a skeletal structure and a skin mesh with associated deformation parameters. The server maps the user's body dimension information to the template parameters by solving a fit function that aims to minimize the difference between the target measurements and the measurements obtained from the deformed model. The server adjusts the scale of individual bones of the skeleton and adjusts shape blend parameters of the mesh to approximate the specified height, chest, waist, and hip sizes. The server thereby constructs a personalized three-dimensional body model with geometry corresponding to the user's measurements.

The server superimposes each garment candidate onto the three-dimensional body model.

The server uses the three-dimensional shape information and the skeleton definitions to bind the garment mesh to the same skeletal structure as the body model. The server then executes shape-fitting processing. In one embodiment, the server performs iterative mesh deformation that brings garment vertices toward the body surface while maintaining garment-specific constraints such as length and looseness. The server may implement a physics-based simulation using a mass-spring model or a position-based dynamics model to simulate cloth behavior under gravity and collision constraints. The server uses collision detection between garment mesh and body mesh to prevent interpenetration and adjusts vertex positions accordingly.

The server executes three-dimensional rendering processing using a graphics engine. The server places a virtual camera and one or more light sources in a scene containing the three-dimensional body model and the superimposed garment candidates. The server computes lighting, shading, and visibility and renders an image of the scene to an image buffer. The server may render multiple views such as front, side, and back. The server thus generates virtual try-on images that visually represent the user wearing each garment candidate. Alternatively or additionally, the server exports the three-dimensional scene data in a standard format, including meshes, textures, camera parameters, and material parameters, to enable interactive rendering on the terminal.

The terminal receives the virtual try-on images or virtual try-on three-dimensional scene data and displays them on the display apparatus. The terminal uses its graphics processing unit and a graphics API to render the received data. When the terminal receives image data, the terminal displays the images as static or animated content. When the terminal receives three-dimensional scene data, the terminal renders the scene in real time and allows the user to rotate or zoom the view by manipulating the input apparatus. The terminal can thus provide an interactive virtual try-on experience in which the user visually assesses the fit and style of garment candidates.

The terminal provides an interface for the user to input evaluation information and preference-change information with respect to the displayed virtual try-on images or virtual try-on three-dimensional scene data. The terminal uses rating controls, selection buttons, and toggles to allow the user to express satisfaction, dissatisfaction, or refined preferences, such as a new preferred color or a different desired style. The terminal transmits this information to the server.

The server stores the evaluation information and preference-change information in the storage device and uses them to update generation and selection behavior. For example, the server can adjust weights in the similarity-calculation step by re-training or fine-tuning the trained inference model using the stored evaluation information as supervision signals. The server can also adapt the prompt-sentence generation by adjusting input templates or modifying parameters of the generative AI model based on aggregated feedback. This feedback loop results in more accurate garment selection in subsequent sessions for the same user or for users with similar preference patterns.

The server optionally uploads the virtual try-on image or virtual try-on three-dimensional scene data to an information-sharing communication network. The server may store the generated image to a content storage service and register a reference in a content-sharing platform. The server sends a link or media object to the platform so that other users can view the virtual try-on result. The terminal may provide a sharing function where the user chooses to post a particular try-on image to a social network. The server associates merchandise identification information with these shared images so that a viewer can request information or purchase the displayed garments.

The server executes a purchase process when a purchase request is received from the terminal. The server uses the merchandise identification information associated with the garment candidate and the virtual try-on content to identify the item in an inventory database. The server verifies availability and retrieves price and shipping conditions. The server then cooperates with a transaction processing apparatus such as a payment processing system or order management system. The server sends transaction data including user account identifiers, item identifiers, quantities, and prices to the transaction processing apparatus and receives confirmation or error responses. The server updates the order status in the storage device and sends a confirmation message to the terminal.

The server thereby implements a pipeline in which the generative AI model and trained inference model are integrated into a broader computer-graphics and transaction-processing architecture. This integration yields several technical effects. Because the server uses the generative AI model to produce a semantically rich prompt sentence that summarizes the structured data, the server can feed a compact, expressive representation into the trained inference model. This reduces the need to handcraft many heuristic rules and allows the trained inference model to exploit semantic relations between style descriptors, color terms, seasonal descriptors, and quantitative constraints. The server therefore achieves improved accuracy in ranking garments relative to conventional rule-based filter systems.

Furthermore, the server precomputes and stores feature vectors for garments and uses a dual-encoder scheme that allows efficient similarity search. The server can use approximate nearest-neighbor search indices to quickly retrieve top candidates, reducing computation time even when the garment information set is large. The server can achieve lower latency and improved throughput compared with naive exhaustive similarity calculations or purely rule-based filtering systems.

Because the server binds the garment selection directly to three-dimensional shape information and to a parametric three-dimensional body model, the system avoids generating try-on scenes for garments that are incompatible with the user's size. The server thus reduces unnecessary rendering tasks and network transfers. This results in lower communication load and more efficient use of graphics resources. The server can also adapt mesh-fitting and rendering parameters based on device capabilities of the terminal, such as resolution and graphics performance, further optimizing computational load.

The generative AI model and trained inference model are trained with explicit loss functions and optimization algorithms. In one embodiment, the generative AI model is trained using teacher-forcing and cross-entropy loss on a corpus of input-output pairs where structured user profiles are associated with manually authored prompt sentences. The trained inference model is trained with contrastive loss to bring matching prompt-garment pairs closer in the feature space and push non-matching pairs farther apart. The server updates model parameters using gradient-based optimization methods such as stochastic gradient descent or adaptive moment estimation. The server may employ data augmentation strategies such as paraphrasing of style descriptions, scaling of measurement values within reasonable ranges, and random masking of some preference fields to improve robustness.

Because the models are trained and deployed to specifically handle structured fashion-related data, three-dimensional shape information, and feedback-based update mechanisms, the behavior of the system is not a mere automation of human manual selection. The server performs high-dimensional vector computations, matrix multiplications, non-linear activations, and iterative optimization that are infeasible to replicate with mental calculations or simple rule tables. The server thus improves computer technology itself by enabling more efficient management of large-scale garment information sets, better utilization of vector indices, and optimized three-dimensional rendering triggered by semantic prompt-based selection.

In another embodiment, the server extends the same architecture to objects other than garments. The server receives specification information and modification-desire information for a target object such as an equipment component or a personalizable structure. The server generates a prompt sentence describing a desired modification plan and inputs this prompt sentence to a generative AI model or another trained inference model configured for the corresponding domain. The server outputs a modification plan that may include updated configuration parameters, structural arrangements, or graphical representations of the modified object. The server may again use three-dimensional modeling and simulation to visualize the modification plan. Thus, the system provides a generalized prompt-driven, model-based computational workflow that improves the efficiency and accuracy of modification planning across different object categories.

Because the server employs particular data structures, neural network architectures, and rendering algorithms, and because the server controls both storage and computation as described, the invention achieves concrete technical improvements. These improvements include faster retrieval and ranking of relevant items, reduced redundant rendering and network traffic, more accurate and personalized virtual try-on results, and an adaptive feedback loop that adjusts computational parameters based on observed user behavior. These effects are realized through specific configurations and structured processing sequences on computer hardware, rather than through an abstract idea implemented at a high level.

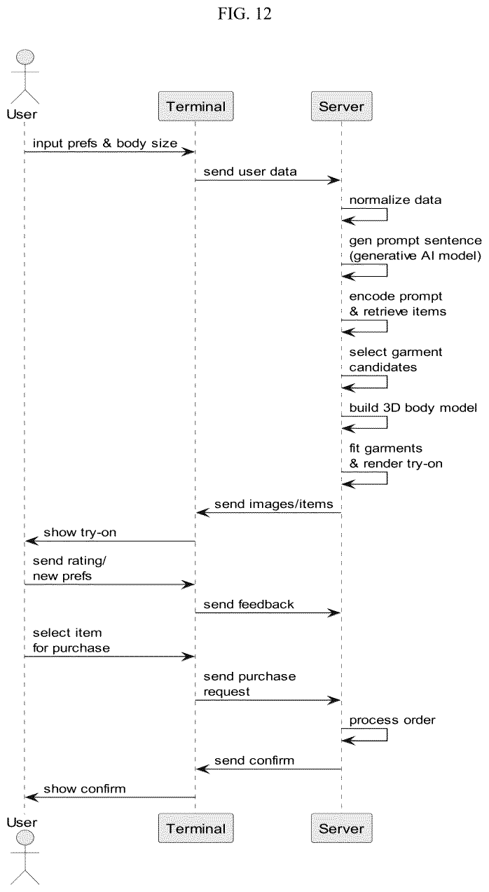

The following describes the processing flow using FIG. 12.

### Step 1:

User operates the terminal to input preference information and body dimension information.

User views, on the terminal's display apparatus, input fields for preferred colors, styles, budget, season, and text or numeric fields for height, chest, waist, hip, and other body dimensions. User touches widgets, types values, or selects options to provide these inputs.

Input: raw user operations (touch events, key presses, selections).

Output: structured input values (e.g., strings for colors/styles, numbers for measurements) stored temporarily in the terminal's memory.

### Step 2:

Terminal converts the raw input into a structured data record and transmits it to the server. Terminal validates the values (for example, checks that height and waist are positive numeric values and that required fields are not empty), normalizes some formats (for example, converts “170” to “170.0 cm”), and stores the result in a key-value structure. Terminal then serializes the structure into a message format and sends it via the communication module to the server over a network.

Input: structured input values from Step 1.

Output: serialized structured data record (e.g., a message including fields for color, style, budget, season, and body dimensions) transmitted to the server.

### Step 3:

Server receives the structured data record and normalizes it into an internal representation. Server parses the message, extracts each field, and converts raw strings and numbers into normalized forms, such as mapping “blue” to a standardized color code, mapping “casual” to an internal style code, and converting all lengths to a common unit. Server may also clip unrealistic values to acceptable ranges. Server then stores the normalized record in the storage device.

Input: serialized structured data record received from the terminal.

Output: normalized internal user profile (including normalized preference information and body dimension information) stored in server-side data structures and in persistent storage.

### Step 4:

Server constructs an encoder input sequence for a generative AI model based on the normalized user profile.

Server concatenates fields into a descriptive template, such as “Color: blue; Style: casual; Season: spring; Budget: under 100; Height: 170 cm; Waist: 75 cm.” Server tokenizes this sequence into tokens using a tokenizer associated with the generative AI model and maps each token to an integer ID. Server then creates position indices for each token and forms an encoder input matrix of token IDs and positions.

Input: normalized internal user profile from Step 3.

Output: tokenized encoder input sequence (token ID sequence and position indices) prepared for the generative AI model.

### Step 5:

Server executes the generative AI model to generate a prompt sentence.

Server feeds the encoder input sequence into the encoder part of a transformer-based generative AI model. The encoder computes contextual embeddings for each token using attention layers and feed-forward layers. The decoder then receives these embeddings and an initial start token, and iteratively predicts probability distributions over a vocabulary for the next token. Server selects each next token using a decoding strategy such as beam search, appends it to the output sequence, and repeats until an end-of-sequence token is produced. Server converts the resulting token sequence to text to obtain a natural-language prompt sentence.

Input: tokenized encoder input sequence from Step 4.

Output: prompt sentence (natural-language text) describing conditions for garment recommendation, such as “The user prefers blue casual clothing suitable for spring and has a total budget under 100 USD. The user's height is 170 cm and the waist size is 75 cm. Based on these conditions, generate a list of specific tops and bottoms that match the user's style, fit the user's body size, and are appropriate for everyday wear.”

### Step 6:

Server encodes the prompt sentence into a feature vector for similarity-based retrieval.

Server applies a text-encoding network, such as a transformer encoder or bidirectional recurrent network, to the tokenized prompt sentence. The network computes hidden-state vectors for each token and aggregates them (for example, by selecting a special classification token or by averaging) into a single high-dimensional feature vector. This feature vector represents the semantic content of the prompt sentence.

Input: prompt sentence from Step 5.

Output: prompt feature vector (e.g., a fixed-length numerical vector) stored in memory for subsequent retrieval operations.

### Step 7:

Server retrieves and encodes garment descriptions into feature vectors (precomputed or on demand).

Server accesses the garment information set stored in the storage device and obtains text descriptions and attribute fields for each garment. For garments without precomputed vectors, server runs the same or a compatible text-encoding network to convert their descriptions into garment feature vectors. Server may pre-store these vectors in an index structure optimized for similarity search.

Input: garment descriptions and attributes from the garment information set.

Output: set of garment feature vectors associated with garment identifiers and stored in an index.

### Step 8:

Server computes similarity scores between the prompt feature vector and the garment feature vectors and applies constraints.

Server calculates similarity metrics (for example, cosine similarity) between the prompt feature vector and each garment feature vector. Server then applies rule-based adjustments using the normalized user profile: it reduces scores for garments outside the user's budget, excludes garments whose size ranges do not cover the user's body dimension information, and boosts scores for garments that match preferred colors and seasons. This is implemented as arithmetic operations on similarity scores and filtering operations on garment attribute fields.

Input: prompt feature vector from Step 6 and garment feature vectors with attributes from Step 7, plus normalized user profile from Step 3.

Output: filtered and re-weighted similarity scores for garments, with a ranked list of garment identifiers.

Server selects garment candidates and gathers their attribute information and three-dimensional shape information.

Server sorts garments by their adjusted similarity scores and selects top-ranked items as garment candidates. Server then queries the storage device to retrieve attribute information (e.g., category, color, size, price) and three-dimensional shape information (e.g., mesh data and skeleton data) for each candidate. Server builds a data structure that associates each candidate ID with its attributes and three-dimensional shape definitions.

Input: ranked list of garment identifiers from Step 8.

Output: garment candidate list including attribute information and three-dimensional shape information for each selected item.

### Step 10:

Server generates or deforms a three-dimensional body model of the user based on body dimension information.

Server retrieves a parametric human-body template model from the storage device and reads the user's body dimension information from the normalized profile. Server runs a fitting routine that maps each measurement (height, chest, waist, hip, shoulders) to scaling factors and shape parameters of the template model. For example, server solves an optimization problem that minimizes the squared error between the actual measurements and model-derived measurements by iteratively adjusting bone scales and shape blend weights. The resulting parameter set is then applied to the template to produce a personalized three-dimensional body model.

Input: parametric body template data and body dimension information from Step 3.

Output: personalized three-dimensional body model data (including skeletal and mesh data) adapted to the user's measurements.

### Step 11:

Server fits each garment candidate onto the three-dimensional body model through shape-fitting processing.

Server loads each garment's three-dimensional shape information and binds the garment mesh to the skeleton of the body model. Server performs collision detection between garment vertices and body mesh surfaces and uses a cloth-fitting algorithm to adjust vertices so that the garment drapes naturally without intersecting the body. Server may execute iterative solver steps simulating fabric constraints and body collision constraints, adjusting vertex positions until a convergence threshold is reached.

Input: personalized three-dimensional body model from Step 10 and three-dimensional garment shape information from Step 9.

Output: fitted garment-body combined models for each garment candidate, each including updated garment mesh coordinates and material assignments.

### Step 12:

Server renders virtual try-on images or generates virtual try-on three-dimensional scene data. Server configures virtual cameras and lighting conditions around the fitted garment-body models. Server performs three-dimensional rendering by projecting the scene onto image planes, computing shading based on materials and light sources, and writing color values into image buffers. For static output, server produces two-dimensional images from selected viewpoints. For interactive output, server constructs scene data including mesh data, texture references, camera configuration, and scene graph structures suitable for real-time rendering on the terminal.

Input: fitted garment-body combined models from Step 11 and rendering configuration parameters.

Output: virtual try-on images and/or virtual try-on three-dimensional scene data prepared for transmission.

### Step 13:

Server sends virtual try-on content and associated item data to the terminal.

Server packages the virtual try-on images or three-dimensional scene data together with garment attribute information, merchandise identification information, and the original prompt sentence. Server serializes this package and transmits it via the communication interface to the terminal.

Input: virtual try-on content from Step 12, garment candidate list from Step 9, and prompt sentence from Step 5.

Output: response message containing visual content, item metadata, and prompt sentence delivered to the terminal.

### Step 14:

Terminal receives the response, renders the virtual try-on content, and displays it to the user. Terminal deserializes the response, caches media assets, and uses its graphics processing unit to display images or to render three-dimensional scenes. For images, the terminal draws them in a gallery or detail view; for scene data, the terminal loads meshes and textures into a graphics engine and renders them in real time.

Input: response message from Step 13.

Output: displayed virtual try-on views on the terminal's display apparatus, visible to the user.

### Step 15:

User evaluates the displayed virtual try-on content and optionally modifies preferences. User observes the rendered outfits and interacts with controls on the terminal to rate items, indicate likes or dislikes, or change preference settings (for example, changing color preference from blue to black, or budget from under 100 to under 150).

Input: displayed virtual try-on content from Step 14 and interactive controls.

Output: evaluation information (ratings, selections) and preference-change information (updated preferences) captured by the terminal.

### Step 16:

Terminal sends evaluation information and preference-change information to the server. Terminal aggregates the user's ratings and new preference selections into structured records, validates them, and transmits them via the communication module as update messages to the server.

Input: evaluation information and preference-change information from Step 15.

Output: structured feedback records delivered to the server.

### Step 17:

Server stores feedback and updates model behavior or selection parameters.

Server writes the received evaluation information and preference-change information to the storage device, indexing them by user and by garments. Server may adjust weight parameters for similarity scoring or trigger background fine-tuning of the trained inference model or generative AI model using the stored feedback as training signals. The adjustment can include recalibrating score weights for colors, styles, or fits and updating the prompt template patterns.

Input: structured feedback records from Step 16.

Output: updated configuration parameters and, over time, updated model weights that influence future prompt sentence generation and garment candidate selection.

### Step 18:

User selects a garment candidate for purchase on the terminal.

User reviews item details associated with a displayed virtual try-on image, then activates a

“Buy” or “Add to cart” control.

Input: displayed item information from Step 14.

Output: purchase selection event captured by the terminal.

### Step 19:

Terminal sends a purchase request to the server including merchandise identification information.

Terminal constructs a purchase request message containing user identifiers, the selected merchandise identification information, chosen size, and quantity. Terminal transmits this message through the communication module to the server.

Input: purchase selection event from Step 18.

Output: structured purchase request delivered to the server.

### Step 20:

Server executes a purchase process in cooperation with a transaction processing apparatus. Server receives the purchase request, validates availability by querying the inventory in the storage device, and then forwards transaction details to a transaction processing apparatus. Server handles responses, updates order status records, and generates confirmation data.

Input: structured purchase request from Step 19 and current inventory and pricing data.

Output: transaction result (confirmation or error) and updated order records, which the server can send back to the terminal for display to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional virtual try-on systems and online customization systems suffer from several technical limitations in the way digital images are generated, processed, and delivered by computer systems. In many existing implementations, a server simply retrieves pre-rendered images or performs basic two-dimensional compositing, without deeply integrating user-specific three-dimensional body models and dynamically generated instructions for advanced image generation. As a result, server-side resources are used inefficiently, generated images often fail to preserve user-specific body proportions, and additional computation is repeatedly performed for each variation of clothing or background, causing unnecessary processing overhead and latency.

Furthermore, known systems do not tightly couple three-dimensional model generation, intermediate rendering, and generative AI image synthesis into a unified processing pipeline. In typical architectures, a generative AI model is invoked with generic or manually crafted text instructions that are not programmatically derived from structured user data, product attributes, and rendered three-dimensional scenes. This leads to unstable output quality, inconsistent fit representation, and increased need for manual post-editing, thereby reducing the effectiveness of computer resources and degrading the responsiveness of the system. Additionally, conventional systems do not adequately utilize user feedback data, such as evaluations or opinions on generated images, to refine subsequent prompt sentence generation and product proposal logic at the system level. As a result, the server cannot adapt its computation path based on historical feedback, and the underlying image generation and recommendation processes are not optimized over time, which causes suboptimal usage of storage, network, and processing resources.

In the context of generating modification plans for objects such as vehicles or other items, existing systems similarly lack a mechanism to translate structured modification request data (including shape information, decorative requirements, and functional requirements) into machine-generated prompt sentences that effectively constrain and guide a generative AI model. Without such a mechanism, the server fails to systematically generate consistent, technically constrained modification proposals, and must rely on ad hoc or manual input, resulting in higher computational trial-and-error, increased bandwidth consumption, and degraded user-perceived performance.

Accordingly, there is a need for a computer-implemented system that technically improves the processing pipeline for virtual try-on and object modification planning by: (i) generating and maintaining user-specific three-dimensional model data from structured body dimension data, (ii) producing intermediate image data through a controlled three-dimensional or image processing stage, (iii) programmatically constructing prompt sentences for a generative AI model based on multi-source structured data, and (iv) using feedback and purchase behavior to update generation and proposal conditions. Such a system should improve the efficiency, determinism, and quality of server-side image generation, reduce redundant computation and data transfer, and provide more accurate and stable visual outputs while maintaining scalability on shared computing resources.

The specific processing by the specific processing unit 290 of the data processing device 12 in Example 2 is realized by the following means.

The present invention provides a server comprising a processor and a memory, the processor being configured to execute instructions stored in the memory to (i) receive, via an information processing terminal, structured user body dimension data and user preference data through a network interface; (ii) control a three-dimensional modeling engine to compute shape parameters for a reference model and generate user-specific three-dimensional model data that is stored in the memory; (iii) access clothing data and product attribute data from a product information storage, and invoke an image processing engine or a three-dimensional rendering engine to virtually apply the clothing data to the three-dimensional model data so as to generate intermediate image data; (iv) automatically construct a prompt sentence in a natural language based on the three-dimensional model data, the intermediate image data, the user preference data, and the product attribute data, and supply the prompt sentence and the intermediate image data as input to a generative AI model to obtain try-on image data; (v) perform post-processing on the try-on image data, including at least one of image quality adjustment, size compression, and additional information superimposition, to generate visual feedback data, and transmit the visual feedback data to the information processing terminal and to an information sharing network; and (vi) manage purchase processing by receiving purchase requests associated with the visual feedback data, coordinating with external inventory management and payment processing systems, and returning purchase results to the information processing terminal. This enables a technically integrated processing pipeline in which the server converts structured user and product data into optimized prompt sentences and intermediate visual representations, thereby improving the determinism, efficiency, and quality of generative AI-based image synthesis, reducing redundant computation and network traffic, and enhancing overall computer system performance for virtual try-on and object modification planning.

The term “processor” refers to one or more hardware-based computation units, such as a central processing unit or a graphics processing unit, configured to execute instructions to perform data processing operations described in the present disclosure.

The term “memory” refers to one or more storage components, such as volatile memory, non-volatile memory, or external storage, configured to store instructions, parameters, model data, product data, and generated image data used by the processor.

The term “information processing terminal” refers to a user-operated electronic device, such as a client computing device, a mobile device, or a workstation, that includes an input/output interface and a communication interface and is configured to exchange data with the server through a network.

The term “body dimension data” refers to structured numerical or categorical data representing physical measurements or characteristics of a user's body, including but not limited to height, weight, circumferences, lengths, and widths of body parts.

The term “preference data” refers to structured data representing a user's tastes, likes, or desired attributes, including but not limited to preferred styles, colors, fits, categories of items, and environmental or background conditions for visual outputs.

The term “structured data” refers to data that is organized according to a predefined schema or format, such as key-value pairs, records, or objects, enabling deterministic parsing and processing by the processor.

The term “communication network” refers to a wired or wireless network infrastructure, such as a local area network or a wide area network, that enables data transmission between the server and one or more information processing terminals.

The term “three-dimensional modeling engine” refers to software or a combination of software modules configured to manipulate three-dimensional geometric data, including deformation of meshes, calculation of shape parameters, and generation of three-dimensional model data.

The term “reference human model” refers to baseline three-dimensional geometric data representing a generic human body, including mesh and skeleton information, that is subject to transformation to generate a user-specific three-dimensional model.

The term “shape parameters” refers to numerical or symbolic parameters that control deformation or scaling of a three-dimensional model, such as lengths, widths, radii, and transformation coefficients associated with body parts.

The term “three-dimensional model data” refers to digital data representing a three-dimensional object, including vertices, edges, faces, textures, and associated metadata, that can be manipulated or rendered by a three-dimensional modeling engine or rendering engine.

The term “product information storage” refers to one or more storage components or databases configured to store product-related data, including clothing data, product attribute data, and identifiers associated with items.

The term “clothing data” refers to digital data representing a garment or wearable item, including three-dimensional garment models, two-dimensional texture data, pattern data, size information, and metadata describing fit or style.

The term “product attribute data” refers to structured data describing characteristics of a product, including type, category, size, color, material, style, brand category, and other attributes used in selection and visualization.

The term “image processing engine” refers to software or a set of software modules configured to manipulate two-dimensional image data, including compositing, color adjustment, filtering, and transformation operations.

The term “three-dimensional rendering engine” refers to software or a set of software modules configured to generate two-dimensional images from three-dimensional model data by simulating lighting, shading, camera viewpoints, and material properties.

The term “intermediate image data” refers to image data generated by virtually applying clothing data to three-dimensional model data before processing by a generative AI model, the image data including visual information that represents an application result of the clothing to the three-dimensional model.

The term “prompt sentence” refers to a text string in a natural language that encodes instructions or constraints for a generative AI model, including descriptions of clothing type, appearance, background, pose, and output quality.

The term “generative AI model” refers to a machine learning model configured to generate image data based on input data including a prompt sentence and optionally one or more reference images, using techniques such as diffusion, generative adversarial learning, or transformer-based generation.

The term “try-on image data” refers to image data output from a generative AI model that visually represents a user or user-specific three-dimensional model wearing one or more items associated with clothing data.

The term “visual feedback data” refers to image data derived from the try-on image data after post-processing, including any adjustments in quality, compression, or added annotations, and intended to be presented to a user as a representation of a virtual try-on result.

The term “image quality adjustment” refers to a processing operation that modifies one or more visual parameters of image data, such as brightness, contrast, saturation, sharpness, resolution, or noise level.

The term “size compression” refers to a processing operation that reduces the file size of image data, for example by changing encoding formats, compression ratios, or resolutions, while maintaining an acceptable level of visual quality.

The term “additional information superimposition” refers to the overlaying of auxiliary content on image data, including text, icons, watermarks, logos, size indicators, or other graphical elements.

The term “information sharing network” refers to a networked service or infrastructure that enables multiple users or systems to access, view, or distribute shared data, including social networks, content distribution networks, or other shared platforms.

The term “product identification information” refers to data that uniquely or distinctively identifies a product, including identifiers such as product IDs, stock keeping units, or other codes used to reference specific items.

The term “purchase request” refers to a data message transmitted from an information processing terminal to the server indicating a user's intention to acquire one or more products, including associated product identifiers, quantities, and user account information.

The term “inventory information” refers to structured data representing the stock status of products, including available quantities, reserved quantities, and location-specific stock records.

The term “settlement information” refers to data related to payment processing for a transaction, including payment method, transaction amount, authorization tokens, and status of payment approval or rejection.

The term “user interface” refers to a set of visual, auditory, or tactile elements presented by an information processing terminal that enables a user to provide input and receive output related to the system's functions.

The term “evaluation information” refers to user-provided data indicating a qualitative or quantitative assessment of visual feedback data, such as ratings, rankings, or categorical judgments.

The term “opinion information” refers to user-provided text or symbolic data that expresses comments, feedback, or suggestions related to visual feedback data or system outputs.

The term “user profile data” refers to stored data associated with a user, including but not limited to demographic information, historical behavior, preferences, past purchases, and feedback history.

The term “proposal conditions” refers to rules, parameters, or criteria used by the system to select or recommend clothing data or other items for visualization or purchase.

The term “modification request data” refers to structured data representing a user's request to modify an object, including shape information, decorative requirements, functional requirements, and other constraints.

The term “shape information” refers to data describing geometric properties of an object, such as dimensions, contours, and structural features that define its form.

The term “decorative requirements” refers to data specifying desired visual or aesthetic changes to an object, including colors, patterns, surface treatments, and stylistic elements.

The term “functional requirements” refers to data specifying desired functional or performance-related changes to an object, including utility, ergonomics, structural modifications, or feature additions.

The term “modification plan” refers to image data or three-dimensional model data that represents a proposed altered state of an object generated based on modification request data.

In one embodiment, a server cooperates with one or more terminals operated by users to implement a virtual try-on and object modification system using a generative AI model. The server includes a processor, a memory, a network interface, and access to storage devices. The terminal includes an input device such as a touchscreen or keyboard, a display device such as an LCD or OLED panel, a local processor, a local memory, and a communication interface such as a wireless transceiver.

The user operates the terminal to input body dimension data and preference data. The terminal executes an application, for example a native mobile application or a web browser, that presents structured input fields for numerical values such as height, weight, shoulder width, and waist circumference, and for preference options such as preferred garment category, color, fit, and background style. The terminal converts the user input into a structured data object, such as a JSON record with predefined keys and numeric values, and stores the object in local memory. The terminal then uses a secure transport protocol such as HTTPS over TLS to transmit the structured data object to the server via the network interface.

The server receives the structured data object and stores it in the memory and in a database management system such as a relational database. The server normalizes the body dimension data by converting physical units (e.g., centimeters, kilograms) into internal units used by a three-dimensional modeling engine. The server computes a set of shape parameters, such as normalized torso length, leg length, arm length, shoulder breadth, and waist-to-hip ratio, that are mapped to morph targets or bone length parameters of a reference human model.

The server invokes three-dimensional modeling software, such as a general-purpose 3D modeling engine running in headless mode, to generate three-dimensional model data representing the user's body shape. The server provides to the modeling engine the reference human model and a script or configuration that defines a mapping from the computed shape parameters to mesh deformation parameters and skeletal transformations. The modeling engine applies non-linear scaling, vertex displacement, and bone length adjustment to the reference human model, recomputes vertex normals and skinning weights, and outputs a user-specific three-dimensional avatar model in a standard interchange format such as GLTF or FBX. The server stores the resulting three-dimensional model data in the memory and assigns a unique identifier linked to the user.

The server retrieves clothing data from a product information storage. The clothing data includes one or more of: (i) a three-dimensional garment mesh with its own skeleton or attachment points; (ii) two-dimensional texture maps indicating color, pattern, normal maps, and material properties; and (iii) product attribute data such as category, target gender, size options, and typical fit (e.g., slim fit, loose fit). The server uses a three-dimensional simulation or fitting module to align the garment mesh to the user-specific three-dimensional model. The simulation module performs collision detection and constraint-based mesh adjustment so that the garment mesh conforms to the body mesh without self-intersections.

The server automatically adjusts garment size parameters (for example, chest width and sleeve length) using the body dimension data and garment size metadata.

The server then uses a three-dimensional rendering engine integrated into the modeling software to generate intermediate image data. The server places virtual cameras around the user-specific three-dimensional model, sets lighting conditions, and assigns materials based on the clothing textures and body surface textures. The rendering engine performs rasterization or ray tracing to generate two-dimensional rendered images in one or more views, such as front, side, and back, each showing the user-specific model wearing the selected clothing. The server stores these rendered images as intermediate image data in an image storage area.

The server constructs a prompt sentence for a generative AI model based on multiple data sources, including the user-specific three-dimensional model data, the intermediate image data, the preference data, and the product attribute data. The server executes a prompt generation module that maps structured fields to natural language phrases according to predefined templates and rules. For example, when the product attribute data indicates a dress, color red, and length to the knee, and the preference data indicates a plain studio background and a neutral pose, the server generates a prompt sentence such as:

“Generate a photorealistic full-body image of the user's three-dimensional model wearing a red knee-length dress with a fitted waist, standing in a relaxed neutral pose against a plain white studio background. Preserve the body proportions from the input model and clearly show the fit around the shoulders, waist, and hips.”

In another example, when the user selects casual clothing items, the server generates a prompt sentence such as:

“Using the provided avatar render as a reference, create a high-resolution image where the avatar is wearing a casual blue denim jacket and black skinny jeans, suitable for online fashion try-on. Emphasize realistic fabric texture, natural lighting, and accurate fit around the arms and legs.”

The server can also generate negative prompt phrases to suppress unwanted artifacts, such as: “no extra limbs, no distorted hands, no blurred face, no duplicated clothing.”

The server supplies the generated prompt sentence, together with one or more of the intermediate images, to a generative AI model for image generation. In one embodiment, the generative AI model is a text-and-image-conditioned diffusion model implemented as a neural network. The model includes a text encoder, for example a transformer-based encoder, that converts the prompt sentence into a sequence of embedding vectors. The model also includes an image encoder, such as a convolutional or vision-transformer-based network, that encodes the intermediate image data into a latent representation. The model combines these embeddings and feeds them into a denoising UNet-based architecture that iteratively refines a noisy latent image into a coherent output consistent with the textual and visual constraints.

The server executes the generative AI model on specialized hardware such as a graphics processing unit or a tensor processing unit, with configurable inference parameters including the number of denoising steps, a guidance scale factor that balances adherence to the prompt versus diversity, and a random seed that controls output variability. The server thereby obtains try-on image data that more accurately matches the user-specific proportions because the generative AI model receives both the rendered reference images and detailed prompt sentences derived from structured body dimension data and product attributes.

The server post-processes the try-on image data using an image processing engine. The server performs at least one of the following operations: (i) image quality adjustment, such as contrast enhancement, color balance correction, and noise reduction using convolution-based filters; (ii) size compression, such as re-encoding the image at a lower resolution or with higher compression ratio while maintaining acceptable detail; and (iii) additional information superimposition, such as overlaying product identifiers, size indicators, or watermarks in specified regions of the image. The server thereby generates visual feedback data optimized for transmission and display by the terminal.

The server transmits the visual feedback data to the terminal via the network interface. The server can either send the binary image data directly or send a URL pointing to an image stored in a content delivery system. The terminal receives the visual feedback data and decodes the image using a graphics subsystem. The terminal presents the image in a user interface that allows zooming, scrolling, and optional comparison between different clothing items or sizes. The user visually inspects the appearance and can decide whether to request additional variations or proceed to purchase.

The terminal also provides an interface for the user to enter evaluation information or opinion information regarding the visual feedback data. The user can assign a numerical rating, select categorical options such as “fit is too tight” or “color is not as expected,” and add free-form comments. The terminal transmits this feedback as structured data to the server. The server stores the feedback in association with the user profile data and product attribute data in the database. The server uses this information to adjust subsequent prompt generation templates, such as adding clarifying constraints about looseness or emphasizing certain fabric properties, and to update proposal conditions so that future clothing recommendations are more aligned with actual user responses.

The server processes purchase requests based on the visual feedback data. The user selects a purchase option on the terminal, which causes the terminal to send a purchase request including product identification information, size, color, and quantity. The server verifies the request, accesses inventory information from an inventory management system, and prepares settlement information for a payment processing system. The server initiates a payment transaction via a payment gateway API and waits for authorization. When the transaction is approved, the server records the order in an order management database and returns a confirmation response to the terminal. In this way, the server coordinates both image generation and transactional processing in an integrated system.

In another embodiment, the server uses a similar processing pipeline to generate modification plans for objects such as vehicles or other physical items. The user uses the terminal to input modification request data, including shape information, decorative requirements, and functional requirements. The server maps the modification request data to a structured description of an object, generates a prompt sentence describing the desired modifications, and optionally generates an intermediate three-dimensional scene or outline illustration. An example of such a prompt sentence is:

“Generate a high-resolution side-view image of a vehicle with a streamlined body kit, matte black exterior finish, and red accent lines along the lower side panels, based on the provided base model outline. Maintain the original wheelbase and door positions, and clearly show the added aerodynamic components.”

The server provides this prompt sentence, and optionally reference images or model data, to the generative AI model and obtains image data or three-dimensional model data representing a proposed modification plan. The same post-processing, storage, and feedback mechanisms can be applied. The user can review the modification plan on the terminal, provide feedback, and request further refinements.

From a technical standpoint, the server improves computer performance and resource utilization by separating the processing into specialized stages with well-defined data structures. The server first uses deterministic geometric processing in the three-dimensional modeling engine to enforce correct body proportions and garment fit, thereby reducing the burden on the generative AI model, which can concentrate on texture realism, lighting, and minor shape refinements instead of reconstructing complete geometry from scratch. This staged approach reduces the number of inference steps and the size of the latent search space needed for the generative AI model, which in turn lowers computation time and energy consumption.

The server also centralizes prompt generation logic in a dedicated module that uses structured input fields and rule-based templates. By programmatically generating prompt sentences from structured data, the server avoids the variability and inefficiency associated with human-authored prompts, leading to more stable and reproducible image outputs. The server can cache intermediate image data and model embeddings so that minor variations, such as color or background changes, do not require full recomputation, further improving throughput and reducing communication load.

In one training configuration of the generative AI model, the server, or an associated training subsystem, uses a supervised learning process. The model is trained on pairs of text descriptions and images, optionally conditioned on three-dimensional renderings. A loss function such as a weighted combination of pixel-wise reconstruction loss, perceptual loss computed on feature maps of an auxiliary network, and contrastive loss between text and image embeddings is minimized using stochastic gradient descent or a variant such as Adam. The model weights are updated iteratively over a large dataset stored in a training data storage. Data augmentation techniques, such as random cropping, color jittering, and geometric transformations, are applied to improve robustness. As a result, the deployed generative AI model is capable of mapping the specific prompt sentences and reference images produced by the server to high-quality outputs with reduced error and variability.

The server implements non-conventional rules to integrate user feedback into the pipeline. For example, the server computes statistics on ratings and textual comments using natural language analysis modules and uses these statistics to adjust prompt templates, such as increasing emphasis on “loose fit” when many users complain about tightness in particular size ranges. The server also modifies weighting of garment selection criteria so that clothing items that have historically produced low user satisfaction are deprioritized in subsequent proposals. This continuous adaptation is implemented in the server logic and is not a simple human workflow automation; it directly modifies how the computer constructs intermediate data structures, selects training-like parameters for inference, and schedules GPU-intensive tasks, thereby improving computational efficiency and output accuracy over time. In a further embodiment, the server uses alternative generative architectures, such as transformer-based autoregressive image generators or generative adversarial networks, while maintaining the same overall structure of using three-dimensional model data and intermediate images as conditioning information. The server can also deploy multiple generative AI models specialized for different categories (e.g., dresses, outerwear, footwear) and select or ensemble models based on the product attribute data. This modular architecture allows the server to scale horizontally, dispatching different generations to different hardware nodes, reducing queue times and balancing computation load across processing resources. By structuring the flow of body dimension data, three-dimensional model data, intermediate image data, prompt sentences, and try-on image data into distinct, interlinked stages governed by explicit algorithms and data structures, the server achieves technical improvements in processing speed, image accuracy, and communication efficiency. The system thereby provides a concrete technical implementation that goes beyond abstract data manipulation or human task automation and delivers measurable enhancements in the operation of computer hardware and software used for virtual try-on and object modification planning.

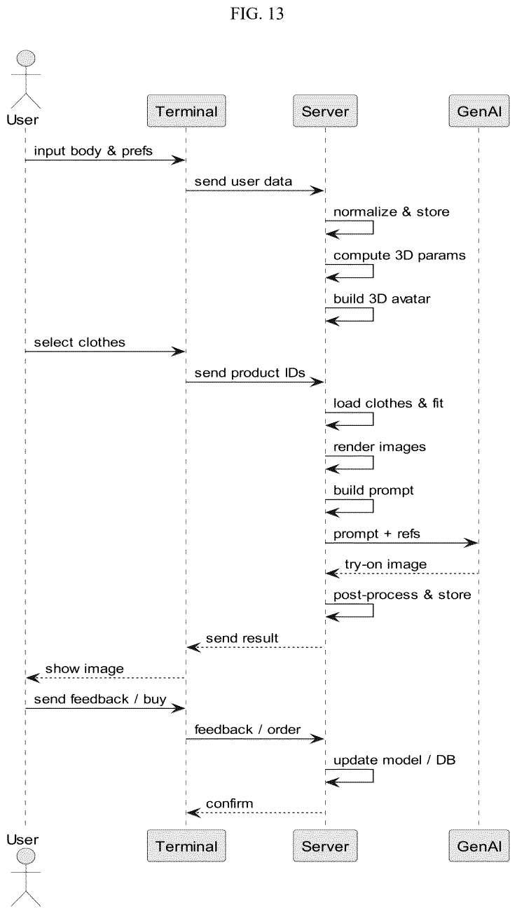

The following describes the processing flow using FIG. 13.

### Step 1:

The user inputs personal data on the terminal.

The user operates an application on the terminal and enters body dimension values (for example, height, weight, shoulder width, chest circumference, waist circumference, hip circumference, leg length) and preference data (for example, preferred clothing category, color, style, background type, and pose). The terminal receives this raw input as text and numeric values, performs client-side validation (for example, checking that numbers are within a defined range and mandatory fields are filled), and converts the data into a structured record such as a key-value map in memory.

Input: User keystrokes and touch events representing body dimensions and preferences.

Output: A structured user data object stored temporarily in the terminal memory.

### Step 2:

The terminal transmits structured user data to the server.

The terminal serializes the structured user data object into a message format such as JSON, attaches user authentication information (for example, a session token), and initiates a secure HTTPS request to the server via a network interface. The terminal sends the request and waits for an acknowledgment. If a network error occurs, the terminal retries the transmission or notifies the user.

Input: Structured user data object and authentication data in the terminal memory.

Output: A network message containing the structured user data, transmitted to the server and queued for processing.

### Step 3:

The server stores and normalizes the user data.

The server receives the HTTPS request through a web service component, parses the JSON payload, and verifies that all required fields are present and correctly typed. The server converts physical units (for example, centimeters to internal floating-point units) and derives standardized fields such as normalized height and body-mass index. The server then stores the normalized body dimension data and preference data in a database under a user identifier.

Input: Network message containing raw structured user data.

Output: Normalized user body dimension and preference records stored as database entries and cached in server memory.

### Step 4:

The server computes shape parameters for a three-dimensional model.

The server reads the normalized body dimension data from memory and applies a set of transformation formulas to map these dimensions to shape parameters used by a reference human model. For example, the server computes scaling factors for torso, legs, and arms, calculates ratios such as waist-to-hip ratio, and assigns numerical values to morph target parameters. The server packages these shape parameters into a structured configuration for a three-dimensional modeling engine.

Input: Normalized body dimension data from the database or cache.

Output: A set of shape parameter values structured for use by the three-dimensional modeling engine.

### Step 5:

The server invokes a three-dimensional modeling engine to generate a user-specific model.

The server launches a three-dimensional modeling engine in headless mode and passes the reference human model and the shape parameter configuration. The modeling engine performs vertex transformations, bone length adjustments, and skinning recalculation based on the input parameters. The server waits until the engine exports the resulting three-dimensional model file, then retrieves the file and records its path in the database.

Input: Reference human model data and shape parameter configuration.

Output: User-specific three-dimensional model data stored in a file and registered in the database.

### Step 6:

The server retrieves clothing data and associates it with the user model.

The server receives from the terminal (in a separate request) the selected product identifiers and reads corresponding clothing data from a product database, including garment mesh data, texture maps, and product attribute data. The server loads the user-specific three-dimensional model file and the clothing data into a fitting module. The server prepares a combined scene description that specifies how the clothing mesh should be positioned relative to the body model.

Input: Product identifiers from the terminal and user-specific three-dimensional model data.

Output: A combined scene configuration containing clothing meshes, textures, and the user-specific body model.

### Step 7:

The server fits the clothing meshes to the user-specific body model.

The server executes a fitting algorithm in the three-dimensional engine. The engine reads the combined scene configuration, performs collision detection between garment and body surfaces, and applies constraint-based mesh adjustment to remove intersections and adjust garment width and length according to size metadata. The server controls this process by setting solver parameters such as maximum iterations and stiffness coefficients.

Input: Combined scene configuration with clothing and body model data.

Output: A fitted three-dimensional scene in which the clothing meshes conform to the user-specific body model.

### Step 8:

The server renders intermediate image data from the fitted three-dimensional scene.

The server configures one or more virtual cameras (for example, front, side, and back views), sets lighting parameters, and assigns materials derived from clothing textures and skin shaders. The three-dimensional rendering engine processes the scene with these settings, performs lighting and shading calculations, and outputs two-dimensional images. The server stores these rendered images as intermediate image data in an image storage area.

Input: Fitted three-dimensional scene data with camera and lighting settings.

Output: Intermediate two-dimensional images representing the user model wearing the selected clothing.

### Step 9:

The server extracts metadata for prompt sentence construction.

The server analyzes the normalized user data, the product attribute data, and the rendering configuration associated with the intermediate images. The server extracts fields such as garment category, color, length, fit type, background type, and pose description. The server maps these fields to internal tokens used by a prompt generation module.

Input: Normalized user data, product attribute data, and rendering configuration metadata.

Output: A structured metadata record that specifies clothing, background, pose, and rendering characteristics.

### Step 10:

The server generates a prompt sentence for the generative AI model.

The server applies rule-based templates to the structured metadata record. For each token (for example, garment category or color), the server inserts a corresponding phrase into a predefined sentence structure. The server optionally adds negative constraints to avoid undesired visual artifacts. The result is a natural-language prompt sentence such as: “Generate a photorealistic full-body image of the user's three-dimensional model wearing a red knee-length dress with a fitted waist, standing in a relaxed neutral pose against a plain white studio background. Preserve the body proportions from the input model and clearly show the fit around the shoulders, waist, and hips.”

Input: Structured metadata record extracted from user and product data.

Output: A complete prompt sentence in natural language and, optionally, associated negative prompt phrases.

### Step 11:

The server prepares conditioning inputs for the generative AI model.

The server selects one or more of the intermediate images as reference images and, if necessary, resizes them to match input dimensions of the generative AI model. The server encodes identification data linking these images to the corresponding prompt sentence. The server configures inference parameters such as the number of diffusion steps, guidance scale, and seed values.

Input: Intermediate image data and generated prompt sentence.

Output: A generative AI request package containing the prompt sentence, reference images, and inference parameters.

### Step 12:

The server submits the prompt sentence and reference images to the generative AI model.

The server sends the request package to a generative AI model endpoint running on a compute node, such as a GPU server. The generative AI model encodes the prompt sentence using a text encoder, encodes the reference images using an image encoder, and fuses the resulting embeddings. The model then executes an iterative denoising process over latent representations to generate an image consistent with both the text and image inputs. The server waits for the model to return the output image data.

Input: Generative AI request package with prompt sentence and reference images.

Output: Try-on image data produced by the generative AI model and returned to the server.

### Step 13:

The server post-processes the try-on image data.

The server passes the raw try-on image to an image processing module. The module may adjust color and contrast, apply sharpening or denoising filters, and re-encode the image at a specific resolution to reduce file size. The server overlays additional information, such as product identifiers, size labels, or branding elements, at predetermined positions.

Input: Raw try-on image data from the generative AI model.

Output: Visual feedback data comprising a processed and annotated try-on image suitable for display and transmission.

### Step 14:

The server stores and indexes the visual feedback data.

The server saves the processed image file to an image storage system and creates a database entry linking the image to the user identifier, product identifiers, and generation parameters.

The server records timestamps and any associated feedback placeholders to support later retrieval and analysis.

Input: Visual feedback data and associated user/product metadata.

Output: A stored and indexed visual feedback record accessible by user and system identifiers.

### Step 15:

The server delivers the visual feedback data to the terminal.

The server generates a response message containing either the image data itself or a URL pointing to the stored image. The server sends this response via HTTPS to the terminal. The server may include additional fields describing the image, such as view type (front, side, back) and resolution.

Input: Indexed visual feedback record and terminal request context.

Output: A network response delivering the visual feedback data to the terminal.

### Step 16:

The terminal displays the visual feedback image to the user.

The terminal receives the response, parses the message, and, if a URL is provided, downloads the image file using an HTTP request. The terminal decodes the image using its graphics subsystem and renders it on the display within an application view. The user can zoom or pan the image, and the terminal updates the display in real time according to user interactions.

Input: Network response containing visual feedback data or image URL.

Output: A rendered image of the virtual try-on result visually presented on the terminal display.

### Step 17:

The user evaluates the visual feedback and optionally provides feedback.

The user inspects the displayed image and may enter an evaluation, such as a rating or a comment, via the terminal's user interface. The terminal converts this evaluation into a structured feedback record and sends it to the server.

Input: Visual feedback image and user interactions on the terminal.

Output: A structured feedback message containing evaluation or opinion data transmitted to the server.

### Step 18:

The server updates models and proposal conditions based on user feedback.

The server stores the received feedback in a feedback database associated with the corresponding visual feedback record, user profile data, and product attribute data. The server runs an analysis module that aggregates feedback statistics and adjusts internal parameters for prompt templates and clothing proposal logic (for example, increasing emphasis on “looser fit” phrases when many users report tightness).

Input: Structured feedback messages and stored visual feedback metadata.

Output: Updated configuration parameters and prompt template rules stored in server memory and databases.

### Step 19:

The user initiates a purchase based on the visual feedback.

The user selects a purchase option in the terminal application, confirming the desired product, size, and quantity. The terminal assembles this data, including the associated visual feedback identifier, into a purchase request and sends it to the server over HTTPS.

Input: User selection events and visual feedback context on the terminal.

Output: A purchase request message containing product and transaction details transmitted to the server.

### Step 20:

The server processes the purchase request and returns a confirmation.

The server receives the purchase request, verifies product availability by querying inventory information, and prepares settlement information for a payment processing system. The server sends payment details to the payment system, receives authorization, and records the order in an order management database. The server then sends a confirmation message back to the terminal, including order ID and summary information.

Input: Purchase request message with product identifiers and user account data.

Output: An order confirmation response delivered to the terminal and a stored order record in the server-side databases.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional virtual try-on systems and online recommendation engines typically rely on static size tables, manually designed rules, and pre-rendered images. These systems suffer from several technical drawbacks from a computer-technology standpoint. First, a processor often handles heterogeneous data flows (user profile data, images, catalog data, and social feedback) in a fragmented manner, without a unified mechanism to transform these data into machine-interpretable conditions for generative processing. As a result, the system cannot efficiently generate individualized visual content, and the processor is underutilized or forced to execute redundant rendering or rule-based logic.

Second, although generative AI models and prompt sentences are known per se, conventional systems treat prompts as ad-hoc text written by humans or as fixed templates. They do not provide a systematic architecture in which a processor dynamically constructs prompt sentences from structured user feature data, three-dimensional shape information, and feedback signals, and then feeds those prompts, together with intermediate representations such as three-dimensional models, into generative models. Consequently, the generative models cannot fully exploit contextual information, and the computing resources spent on such models do not translate into consistently accurate and personalized outputs. Third, conventional systems do not tightly integrate emotion recognition, three-dimensional modeling, generative image synthesis, and social-feedback analysis into a closed computational loop. Emotion estimation and social reactions, if used at all, are typically processed at the user interface level and are not fed back into the core data processing pipeline that governs candidate selection and prompt construction. This separation prevents the processor from adaptively tuning its selection criteria and generative instructions based on measurable responses, and leads to inefficient use of storage, network, and compute resources, because many generated images are not aligned with the user's actual preferences or emotional state.

Fourth, in the area of customization planning for movable bodies such as vehicles, conventional systems generally provide static configuration tools or rule-based wizards. They do not exploit generative AI models driven by structured prompts derived from user attributes and customization preferences in the same unified architecture that is used for apparel. As a result, there is no common computational framework capable of generating both virtual try-on images for apparel and virtual appearance images for movable bodies based on a shared prompt-generation and feedback-adaptation mechanism.

Accordingly, there is a need for a computer-implemented system in which a processor orchestrates: (i) acquisition and transformation of user attributes, body information, and image data into structured representations including three-dimensional models; (ii) context-aware construction of prompt sentences for generative AI models; (iii) generation of virtual try-on images or virtual customization images based on those prompts and intermediate models; and (iv) adaptive updating of selection rules and prompt-construction rules based on emotion analysis and social-feedback data. Such a system should improve the technical operation of the computer by reducing ineffective generations, increasing the relevance of generated images, and enabling more efficient use of processing, memory, and network resources in data-intensive, generative-AI-driven recommendation environments.

The specific processing by the specific processing unit 290 of the data processing device 12 in Application Example 2 is realized by the following means.

The present invention provides a server comprising a processor configured to acquire preference information and dimension information of a user via a user input/output apparatus, acquire image data of the user via an image sensing apparatus, execute image processing on the image data to estimate a body shape and body size of the user and to generate a three-dimensional shape model of the user, refer to a product information storage area in a storage apparatus using the preference information, the body information, and environment condition information as search conditions to select clothing candidates, construct a prompt sentence for input to a generative information processing model for image generation based on the preference information, the body information, the environment condition information, and the selected clothing candidates, input the prompt sentence and at least one of the three-dimensional shape model and the image data of the user to the generative information processing model to cause generation of a virtual try-on image in which the clothing candidates are virtually worn by the user, output the virtual try-on image to the user input/output apparatus and transmit the virtual try-on image to an information sharing communication infrastructure for registration as publication data in accordance with an operation of the user, acquire evaluation information regarding the publication data from the information sharing communication infrastructure and update at least one of a selection rule for the clothing candidates and a construction rule for the prompt sentence based on the evaluation information and a selection history of the user, and cooperate with an electronic transaction processing apparatus to execute a purchase process for clothing corresponding to the virtual try-on image based on an instruction from the user. This enables the computer system to integrate multi-modal user data, dynamically construct and refine prompt sentences for generative AI models, and iteratively adapt its selection and generation processes based on objective feedback, thereby improving the efficiency, accuracy, and personalization of virtual image generation and recommendation while optimizing utilization of processing, memory, and network resources.

The term “user input/output apparatus” refers to any information processing terminal that presents information to a user and accepts input from the user, including but not limited to portable terminals, head-mounted display devices, and general-purpose computing devices.

The term “attribute information” refers to information indicating static or slowly changing characteristics of a user, such as age group, gender, lifestyle, or general fashion preferences, which is used as a basis for selecting items or generating content.

The term “body information” refers to information indicating physical characteristics of a user, including at least one of height, weight, body circumference values, limb lengths, and posture-related parameters.

The term “preference information” refers to information indicating a user's likes and dislikes with respect to items or styles, including desired colors, styles, materials, silhouettes, price ranges, and usage scenes.

The term “dimension information” refers to quantitative data that expresses sizes of body portions of the user, including but not limited to chest, waist, hip, shoulder width, arm length, and leg length.

The term “image sensing apparatus” refers to a device that acquires image data of a subject, such as a camera integrated into a terminal, an external imaging unit, or a vision sensor.

The term “image data” refers to digital data representing still images or frames of a user, including color images, grayscale images, depth images, or combinations thereof.

The term “image processing” refers to computational operations applied to image data, including at least one of detection, segmentation, feature extraction, measurement, and transformation for the purpose of estimating body shape or generating representations.

The term “body shape” refers to a geometric configuration of a user's body, expressed as a set of contours, surfaces, or volumetric regions that characterize the outer form of the body.

The term “body size” refers to numerical values representing lengths or circumferences of portions of the body of the user, obtained by measurement or estimation from image data.

The term “three-dimensional shape model” refers to digital data representing a three-dimensional form of the user's body, including at least a mesh model, a volumetric model, or skeleton-based model, that can be used for rendering or simulation.

The term “three-dimensional shape model generation apparatus” refers to a computing module that generates a three-dimensional shape model from input data, such as body size values or two-dimensional images, using three-dimensional modeling processing.

The term “product information storage area” refers to a logical storage region within a storage apparatus that holds structured data describing items, including identifiers, sizes, colors, categories, prices, and usage constraints.

The term “storage apparatus” refers to any data storage device or subsystem, including but not limited to semiconductor storage, magnetic storage, optical storage, and network-attached storage, that stores program data and product information.

The term “environment condition information” refers to information indicating external conditions relevant to item selection, including at least one of season, climate, event type, location, time zone, and usage purpose.

The term “clothing candidates” refers to one or more items of apparel or outfit combinations selected from product information based on compatibility with the user's attributes, body information, and environment condition information.

The term “suitability score” refers to a numerical or categorical index that indicates a degree of suitability of an item for a specific user under specific conditions, calculated by the processor based on predefined rules or learned models.

The term “prompt sentence” refers to a text string that encodes a request or instruction to a generative information processing model, describing desired content, style, or constraints for generated output.

The term “generative information processing model” refers to an information processing model that produces new data or content from input conditions, such as a generative neural network, a probabilistic generative model, or a text-to-image generation model.

The term “virtual try-on image” refers to image data in which an item is visually synthesized or rendered as if it is being worn by the user, based on at least one of a three-dimensional shape model and user image data.

The term “user operation” refers to an action explicitly performed by the user on the user input/output apparatus, such as touching, clicking, selecting, or executing a command through a user interface.

The term “information sharing communication infrastructure” refers to a communication system or service that enables transmission and sharing of data among multiple users, including but not limited to social networking services and online content sharing platforms.

The term “publication data” refers to data that has been transmitted to the information sharing communication infrastructure for access by other users, including images, captions, and associated identifiers.

The term “evaluation information” refers to feedback data obtained from the information sharing communication infrastructure, including at least one of reactions, scores, comments, or engagement metrics associated with publication data.

The term “selection rule” refers to logic or parameters used by the processor to determine which items from product information are selected as candidates, based on feature values, scores, or constraints.

The term “construction rule” refers to logic or parameters used by the processor to determine how a prompt sentence is generated, including selection, ordering, and formatting of textual elements representing conditions.

The term “selection history” refers to log data that records past selections, confirmations, purchases, or rejections of items by the user during operation of the system.

The term “electronic transaction processing apparatus” refers to a computing system that performs transaction processing, including order generation, payment authorization, and record management for items purchased by the user.

The term “purchase process” refers to a sequence of operations that results in an order being placed for an item, including selection confirmation, payment processing, and registration of order information.

The term “facial expression information” refers to data representing facial features or images of the user, from which expressions such as happiness, surprise, or neutrality can be inferred.

The term “voice information” refers to audio data acquired from the user, including speech, tone, and prosody, which can be analyzed to infer the user's emotional or intentional state.

The term “emotion determination information processing model” refers to an information processing model configured to infer an emotional state of the user from input data such as facial expression information or voice information.

The term “emotional state” refers to a classification or quantitative representation of a user's psychological condition, including at least one of joy, excitement, neutrality, sadness, or anxiety.

The term “atmosphere expression” refers to a textual or parametric description in a prompt sentence that indicates mood, tone, or stylistic characteristics of content to be generated, such as brightness, vividness, or calmness.

The term “movable body” refers to any movable object that can be customized, including but not limited to vehicles, robots, and other transport or mobile apparatuses.

The term “customization preference information” refers to information indicating a user's desired customization style for a movable body, including preferences for color schemes, exterior parts, interior options, or performance-related features.

The term “change plan” refers to a concept or specification of modifications to be applied to a movable body, including at least one of structural changes, appearance changes, and equipment configuration changes.

The term “proposal information” refers to information generated by a generative information processing model that describes recommended changes, configurations, or designs for a movable body or apparel.

The term “virtual appearance image” refers to image data representing a predicted or designed appearance of a movable body after application of a change plan, synthesized or rendered by the system.

In one embodiment, a server, a terminal, and a user cooperate over a communication network to implement the claimed system. The server includes at least one processor, a main memory, and a storage apparatus such as a relational database and an object storage system.

The terminal includes a display, one or more input units, and an image sensing apparatus such as an integrated camera. The user interacts with the terminal to provide attribute information, body information, and operation commands.

The server executes a program stored in the storage apparatus. The program comprises multiple software modules implemented, for example, in a general-purpose programming language executed on an operating system. The modules include an image-processing module that may utilize an image-processing library (for example, an OpenCV-type library), a three-dimensional model generation module that may control a three-dimensional modeling engine (for example, a Blender-type or Unity-type engine), a recommendation module implemented in a scripting environment (for example, a Python-type environment), a generative AI interface module for communicating with a generative AI model (for example, a DALL-E-type, Stable-Diffusion-type, or GPT-type model), an emotion analysis module that may call an external emotion recognition service (for example, an Azure-Face-type API), and a transaction module for connecting to an electronic commerce backend (for example, a Shopify-type platform).

The terminal presents a graphical user interface implemented, for example, as a native mobile application or a browser-based application. The terminal acquires the user's preference information and dimension information through forms and interactive controls. The terminal also controls its camera to acquire image data of the user, such as a full-body image or a sequence of images. The terminal encapsulates the input data into a structured data object (for example, a JSON-like structure containing fields for preference information, dimension information, and references to image data) and transmits the object via a secure communication protocol to the server.

The server stores the received structured data in a storage apparatus. The server normalizes the data by mapping free-text style descriptors, color names, and size descriptions into canonical codes used internally. For example, the server maps “light blue” and “sky blue” to the same color code, and maps “slim fit” and “tapered” to a normalized silhouette code. The server maintains a user profile record in a relational table, with columns for attribute information, body information, preference information, and identifiers for associated images and three-dimensional models. This explicit data structuring allows the processor to access and update user-related data with low latency and reduced parsing overhead.

The server loads the user's image data into memory and executes a sequence of image-processing operations. The image-processing module uses a convolution-based feature extractor to detect body keypoints such as shoulders, waist, hips, knees, and ankles. In one implementation, the image-processing module uses a keypoint-detection neural network pre-trained on human pose datasets. The network has multiple convolutional layers, pooling layers, and deconvolution layers, and is trained with a mean-squared-error loss on keypoint heatmaps. The server uses these keypoints, together with the user's declared height, to estimate body size values by computing pixel distances and mapping them to physical lengths using a scale factor. The estimated values are stored as dimension information in a dedicated table, with fields for chest circumference, waist circumference, hip circumference, shoulder width, arm length, and leg length.

The server controls a three-dimensional shape model generation apparatus to produce a three-dimensional shape model of the user. The three-dimensional model generation module may control a three-dimensional modeling engine through a script interface. The server retrieves the dimension information and passes it to a parametric human body template. The parametric template is defined by a set of blend-shape parameters or skeletal scaling factors.

The server solves an optimization problem that minimizes a difference between the predicted measurements of the template and the estimated dimension information, for example using a gradient-based optimizer. As a result, the server obtains parameter values that deform the base human mesh so that its measurements match the user's body size. The server then instructs the three-dimensional engine to generate a polygon mesh and, if desired, a normal map and a skin texture. The generated three-dimensional shape model is stored in an object storage and referenced in the user profile.

The server maintains a product information storage area that contains structured data records representing clothing items. Each record may include an item identifier, category, available sizes, color codes, style descriptors, fabric type, seasonal tags, price, and a link to a three-dimensional garment mesh or a canonical garment image. The server executes a recommendation module that reads user profile data, dimension information, environment condition information (for example, season and target occasion), and product data. The recommendation module computes a suitability score for each candidate clothing item using a hybrid algorithm that combines rule-based filters (size compatibility, budget constraints, season compatibility) and a learned scoring function.

In one embodiment, the learned scoring function is implemented as a feed-forward neural network with an input layer that receives a feature vector including encoded user attributes, body-shape descriptors, and product features (colors, categories, price, style embedding). The network may have several hidden layers with non-linear activation functions and an output unit representing a predicted likelihood that the user will select or positively evaluate the item. The network is trained using historical interaction data stored in the system, where each training sample associates a (user, item) pair with a label representing positive feedback (such as purchase, repeated selection, or high social approval) or negative feedback. The server minimizes a cross-entropy loss or mean-squared error loss using gradient descent and updates neural network weights accordingly. This learned scoring function enables the processor to evaluate complex, non-linear correlations between user characteristics and product attributes, which goes beyond simple human-designed rules.

The server selects one or more clothing candidates based on the suitability scores and stores the selected candidates in a candidate set associated with the user session. The server then constructs a prompt sentence to be input to a generative AI model for image generation. The prompt construction module assembles textual components from multiple sources: a description of the user's body shape derived from dimension information, a description of the selected clothing items (category, silhouette, color, style), environment condition information (season, occasion), and optionally an atmosphere expression derived from emotion analysis. In one embodiment, the server employs a language-model-based generative AI model to assist in constructing the prompt sentence. The server formats the user data and clothing candidate data into a structured context text and sends it to a language model, such as a transformer-based model with self-attention layers and positional encoding, trained on a large corpus of text. The server instructs the language model to produce a concise natural-language description suited for controlling an image-generation model. For example, the server may send the following input:

“User emotion: joy. Favorite color: blue. Body size: M. Propose several bright, cheerful fashion outfits suitable for an M-size body, and generate one concise English prompt sentence that can be used to create a virtual try-on image.”

The language model outputs a prompt sentence such as:

“Generate a virtual try-on image of an M-size person wearing a blue, cheerful, casual outfit with bright lighting that reflects a joyful mood.”

The server may further post-process this output, for example by inserting specific garment names and color codes and ensuring that the sentences conform to an internal template. This interaction between structured internal data and natural-language generative models improves the expressiveness and accuracy of prompt sentences compared to static human-designed templates, thus enhancing the performance of downstream image generation.

The server provides the constructed prompt sentence, together with either the three-dimensional shape model or the original user image, to an image-focused generative AI model. In one embodiment, the server uses a diffusion-based image generator that operates by iteratively denoising a noise vector conditioned on a text embedding and optional image conditioning. The server encodes the prompt sentence using a text encoder component of the generative model, and optionally encodes the user's three-dimensional avatar or photograph using an image encoder. The server runs the denoising process for a fixed number of time steps, using a trained network that predicts a noise residual at each step, and obtains a synthesized virtual try-on image. The generative model is previously trained on paired (image, text) data using a loss function such as a denoising score-matching loss. During training, the server or another training system perturbs real images with noise and trains the network to predict the original image content from the noisy version conditioned on the text description. This training method enables the model to generate new images consistent with the semantic content of text prompts.

The server stores the generated virtual try-on images in object storage and registers their identifiers in the user profile and session records. The server also compresses the images, for example using a standard image-compression algorithm, to reduce bandwidth when transmitting to the terminal. The server organizes the virtual try-on images and metadata into a structured response payload that includes, for each image, an identifier, a reference to the associated clothing item, and any auxiliary evaluation metrics.

The terminal receives the virtual try-on images and metadata from the server and renders them in a user interface. The terminal may permit the user to zoom in, rotate three-dimensional visualizations, or adjust basic display parameters. The terminal optionally performs client-side image adjustments such as brightness or contrast modifications using graphical libraries, without affecting the original image stored at the server.

The server cooperates with an information sharing communication infrastructure by exposing an interface that accepts a user's request to share a particular virtual try-on image. Upon receiving such a request, the server or terminal calls an application programming interface of the external platform to upload the virtual try-on image together with a caption and tags. An example of a caption may contain a version of the prompt sentence, such as: “Virtual try-on: light blue casual shirt and dark blue slim jeans in a bright, joyful atmosphere.”

The information sharing communication infrastructure provides identifiers and URLs for the posted content, which the server stores as publication data.

The server periodically retrieves evaluation information from the information sharing communication infrastructure via its APIs. The evaluation information includes numerical counts of reactions, as well as text comments. The server parses the evaluation information and associates it with particular virtual try-on images and clothing items. The server may use a text-analysis submodule to classify comments into positive, neutral, or negative categories using a sentiment analysis model. The server aggregates these metrics into feedback features such as average reaction rate, normalized by time or by user group. The feedback features are written back into the relational database.

The server updates selection rules and construction rules based on evaluation information and selection history. For example, the server maintains a parameterized scoring function for suitability scores and periodically retrains or fine-tunes this function using new feedback features as labels or auxiliary inputs. In some embodiments, the server uses reinforcement-learning-style updates, where a policy network responsible for selecting garments or constructing prompt sentences receives a reward based on social feedback metrics. This provides a technical improvement over static rule-based systems by enabling the processor to adapt selection and generation logic to real-world reaction data, thereby reducing the number of low-relevance images generated and transmitted.

In another embodiment, the server performs emotion analysis based on facial expression information or voice information captured by the terminal. The terminal records short video clips or audio segments while the user views try-on results. The terminal transmits these clips to the server. The emotion analysis module feeds the clips into an emotion determination information processing model, such as a convolutional network for facial image sequences or a recurrent network for audio. The network is trained with labeled emotional data using a cross-entropy loss over emotion classes such as joy, excitement, neutrality, or sadness. The server outputs an emotional state vector and uses it as additional input for both the recommendation module and the prompt construction module. For example, when the emotional state indicates joy, the server may bias color and style selection toward brighter and more vivid items and adjust the prompt sentence to include atmosphere expressions such as “bright,” “energetic,” or “vibrant.” This specific coupling between emotional state estimation and text prompt construction is not a mere automation of human decision-making, but a structured computational feedback loop that adjusts internal parameters and reduces the generation of content mismatched with the user's current mood.

The server also cooperates with an electronic transaction processing apparatus. The transaction module receives a purchase instruction from the terminal, identifies the clothing item and size associated with the selected virtual try-on image, and calls an order-creation interface of the transaction backend. The transaction backend verifies inventory, calculates total price including taxes and shipping, and returns transaction status. The server records the order in an order table and returns confirmation data to the terminal. The technical effect is that the data path from prompt sentence, generative model, virtual try-on image, social evaluation, and final purchase is represented and controlled inside the computing system, permitting end-to-end optimization of data flows and enabling reduction of redundant network calls and database queries.

In another embodiment corresponding to customization of movable bodies, the server acquires attribute information and customization preference information for a movable body, such as a vehicle. The server stores these attributes in a vehicle profile table. The server constructs a prompt sentence that describes the movable body and desired customization style, for example:

“The user owns a white SUV and prefers a sporty customization style; generate a realistic image showing a customized sporty SUV with low-profile tires, aggressive front bumper, rear spoiler, and a black-and-red color scheme.”

The server inputs the prompt sentence to a generative information processing model for text or images. The model outputs proposal information or a virtual appearance image representing a modification plan. The server can further feed this proposal back into a structured representation and store part lists or configuration options. This re-use of a common prompt-construction and generative pipeline for both apparel and movable body customization improves software modularity and reduces the computational overhead associated with maintaining separate engines for each domain.

Multiple variations of the described embodiments are possible. For example, the three-dimensional shape model can be generated not only by parametric mesh deformation but also by assembling a volumetric distance field that approximates the user's silhouette, and then extracting an iso-surface. The generative AI model may be a generative adversarial network, where a generator network and a discriminator network are trained with an adversarial loss in addition to a reconstruction or classification loss. The prompt construction rules may incorporate a grammar-based generator that enforces syntactic constraints to facilitate parsing by specialized encoders. The recommendation module can be implemented with different architectures, such as graph-based models that represent relations among users and items, and training procedures may use mini-batch updates, learning-rate scheduling, and data augmentation methods (for example, random cropping, color jittering on training images) to improve generalization.

The system produces a technical effect in that the server reduces computation and communication overhead by constructing prompt sentences and internal representations that are tightly aligned with the capabilities of the generative AI model, thereby minimizing the number of generations needed to obtain acceptable images. The server improves accuracy by using three-dimensional shape models and rich feature vectors instead of simple height-and-weight tables, thereby reducing fit errors in visual appearance. The server improves data management by maintaining normalized relational schemas for user profiles, three-dimensional models, product data, and feedback, allowing efficient indexed queries with reduced latency. Overall, the described interoperation of modules and data structures improves the functioning of the computer system itself in the context of generative, data-intensive visual recommendation, rather than merely automating manual selection or human visual judgment.

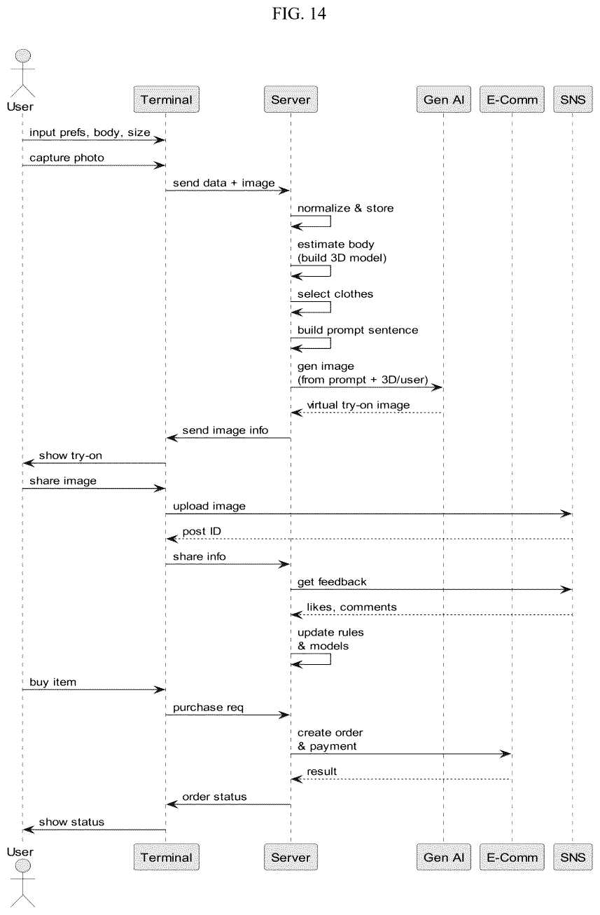

The following describes the processing flow using FIG. 14.

Step 1: The terminal displays input screens for user attributes, preference information, and dimension information.

The user inputs favorite styles, colors, budget, season, and approximate size values (for example, height and weight) into the terminal and confirms the entries.

The terminal activates a camera preview and guides the user to capture at least one full-body image.

Input: raw user entries (text and numeric values) and raw image frames from the camera.

The terminal packages the entries into a structured data object and compresses the selected image, then sends both to the server over a secure communication channel.

Output: a structured request message containing user attribute information, preference information, dimension information, and one or more user images transmitted to the server.

### Step 2:

The server receives the structured request message from the terminal and parses the payload.

The server stores the raw image in object storage and stores normalized user data in a relational database record.

Input: structured request message with user data and an image file.

The server maps free-text fields (for example, “light blue,” “smart casual”) to internal codes using lookup tables, validates numeric ranges for body size and budget, and assigns a session identifier.

Output: a persistent user profile and session record linking normalized attributes, dimension information, and an image identifier.

### Step 3:

The server loads the stored user image from object storage into an image-processing module.

The server applies a keypoint-detection network and image-processing routines to estimate body shape and body size.

Input: user image and initial dimension information (for example, user-declared height).

The server detects body keypoints (shoulders, hips, knees, ankles) and computes pixel distances; the server converts these pixel distances to physical lengths using the user's height as a scaling factor and smooths the measurements using statistical filters to suppress noise.

Output: a body-size vector containing estimated values such as chest, waist, hip circumferences, shoulder width, arm length, and leg length stored in the database.

### Step 4:

The server controls a three-dimensional model generation engine to create a three-dimensional shape model of the user.

Input: body-size vector and a parametric human template model.

The server adjusts mesh parameters or skeletal scale factors of the template by running an optimization algorithm that minimizes differences between template measurements and the body-size vector; the server then generates a polygon mesh for the avatar.

Output: a three-dimensional shape model file stored in object storage and a reference to this file written into the user's session record.

### Step 5:

The server accesses the product information storage area and retrieves candidate clothing items.

Input: user preference information, environment condition information (for example, season and target occasion), budget, and body-size vector.

The server filters items by size compatibility, budget range, and environment tags, and then evaluates each remaining item with a suitability-scoring function that combines rule-based checks and a learned ranking model.

Output: a ranked list of clothing candidates associated with the session and stored in the database.

### Step 6:

The server constructs a prompt sentence for a generative AI model based on user and candidate data.

Input: user preference information, body-size summary, environment condition information, and the ranked list of clothing candidates.

The server assembles textual fragments (for example, body description, garment type, colors, desired mood) and optionally calls a language-model-based generative AI model to refine wording; the server concatenates these components into a single coherent prompt sentence.

Output: a prompt sentence describing a desired virtual try-on image, saved in the session record.

### Step 7:

The server prepares inputs for an image-generation generative AI model.

Input: the prompt sentence, the three-dimensional shape model (or a rendered avatar image), and, optionally, the original user image.

The server renders the three-dimensional shape model into a neutral-pose image if needed, encodes the prompt sentence into a text embedding, and encodes the avatar or user image into an image embedding according to the generative model's interface.

Output: encoded representations and option flags passed to the generative AI model invocation.

### Step 8:

The server calls the image-generation generative AI model to generate a virtual try-on image.

Input: text embedding of the prompt sentence, image embedding of the avatar or user image, and generation parameters (for example, resolution, guidance scale, and iteration count).

The generative AI model applies its internal denoising or generative algorithm to synthesize an image consistent with the embeddings; the server receives the generated pixel data, converts it to a standard image format, and compresses the image.

Output: a virtual try-on image file stored in object storage and registered in the database with links to the user, clothing candidates, and prompt sentence.

The server sends the generated virtual try-on image information to the terminal.

Input: identifiers of virtual try-on images and associated metadata from the database.

The server constructs a response payload containing image URLs, clothing item identifiers, and descriptive text; the server transmits this payload to the terminal.

Output: a response message that allows the terminal to download and display the virtual try-on images.

### Step 10:

The terminal retrieves and displays the virtual try-on images to the user.

Input: response message with image URLs and metadata.

The terminal downloads the images from object storage or a content server, decodes them, and renders them in a gallery interface; the terminal records user interactions such as zoom, swipe, and “favorite” selections.

Output: a visual user interface showing the virtual try-on images and a set of interaction logs stored locally and optionally queued for upload to the server.

### Step 11:

The terminal captures emotional or interaction-related signals while the user views the virtual try-on images.

Input: the current display context and camera or microphone sensor streams.

The terminal records short clips of the user's face or voice and transmits them, together with identifiers of the currently displayed images, to the server; the terminal may also forward local “favorite” flags.

Output: a data packet containing facial expression information, voice information, and interaction markers associated with specific virtual try-on images.

### Step 12:

The server estimates the user's emotional state from the received signals.

Input: facial expression information, voice information, and mapping between the signals and virtual try-on images.

The server applies an emotion determination model to the facial and audio features, computes an emotional state label or vector (for example, joy=0.8, neutrality=0.2), and associates this state with the viewed images and clothing candidates.

Output: an emotional-state record stored in the database and linked to both the session and specific virtual try-on images.

### Step 13:

The server updates recommendation and prompt-construction parameters based on the emotional-state record.

Input: emotional-state record, previous selection history, and performance metrics of past recommendations.

The server adjusts weights or thresholds in the suitability-scoring function and updates rules or templates used for prompt sentence construction, biasing future selections and wording toward items and atmospheres correlated with positive emotional states.

Output: revised selection rules and updated prompt-construction parameters stored in configuration tables or model-parameter storage.

### Step 14:

The terminal provides an option for the user to share selected virtual try-on images via an external information sharing communication infrastructure.

Input: user selection of one or more virtual try-on images and a sharing command.

The terminal prompts the user for a caption and destination platform, then sends a sharing request and image references to the server or directly to the external platform; the caption may incorporate part of the prompt sentence or a simplified version.

Output: an upload transaction to the external platform and identifiers or URLs for publication data returned to the terminal and/or server.

### Step 15:

The server retrieves evaluation information from the information sharing communication infrastructure.

Input: publication data identifiers and access credentials for the external platform.

The server queries the platform's application programming interface to obtain reaction counts, comment texts, and engagement statistics for each shared virtual try-on image; the server parses and normalizes these metrics.

Output: evaluation records containing numerical and categorical feedback values linked to virtual try-on images, clothing items, and user sessions in the database.

### Step 16:

The server incorporates evaluation information into its learning and optimization pipeline.

Input: evaluation records, existing model parameters, and logs of prior recommendations and generated images.

The server updates the learned ranking model or policy by treating positive reactions as reinforcement signals and negative or absent reactions as penalties; the server executes parameter updates for neural-network weights and optionally modifies rule-based coefficients for selection and prompt construction.

Output: an updated set of model parameters and coefficients that will be used in subsequent sessions, improving alignment between generated images and external feedback.

### Step 17:

The terminal allows the user to initiate a purchase based on a specific virtual try-on image.

Input: user action selecting an image and a purchase command.

The terminal sends the image identifier and associated clothing item identifier to the server; the terminal may also transmit shipping preferences or stored profile data.

Output: a purchase request message containing item identifiers, quantities, and user identifiers.

### Step 18:

The server performs an electronic transaction for the selected clothing item.

Input: purchase request message and product inventory/pricing data from an electronic transaction processing apparatus.

The server validates availability, calculates a final price including taxes and shipping, and creates an order record; the server then calls the payment interface to process payment authorization and receives success or failure status.

Output: an order confirmation or error response stored in the order table and returned to the terminal.

### Step 19:

The terminal displays transaction results and optionally updates local state.

Input: order confirmation or error response from the server.

The terminal renders an order summary including item description, price, and delivery information; in case of success, the terminal may store a local record for later reference and present options to share the purchase or revisit associated virtual try-on images.

Output: a visual confirmation to the user and an updated local record of completed purchases.

### Step 20:

The server archives the entire session, including input data, generated prompt sentences, model outputs, emotional states, and evaluation information.

Input: session identifier and all related database records and log entries.

The server aggregates these data into a structured session summary and writes it to long-term storage; the server may periodically mine archived sessions to further refine generative AI model usage patterns, prompt structures, and recommendation strategies.

Output: a persistent session dataset that supports continuous technical improvement of the system's accuracy, efficiency, and generative AI model integration.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

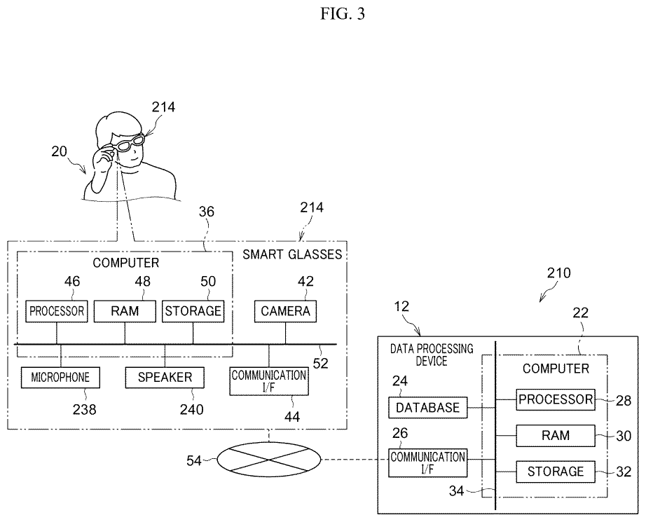

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

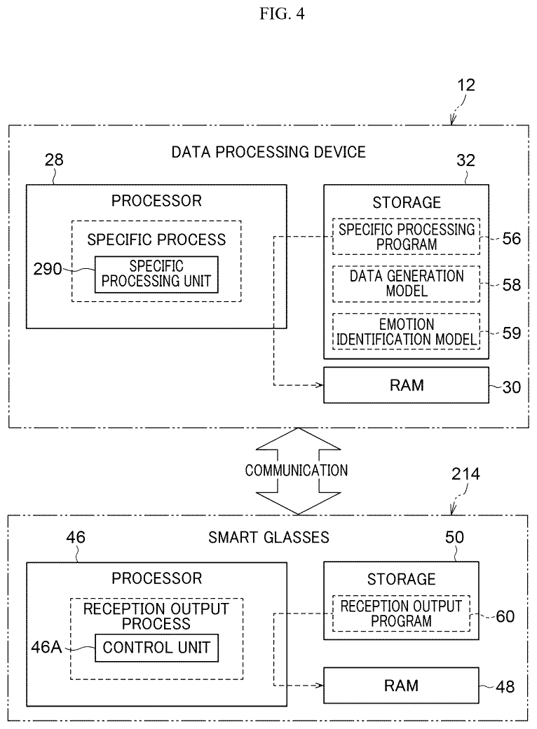

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

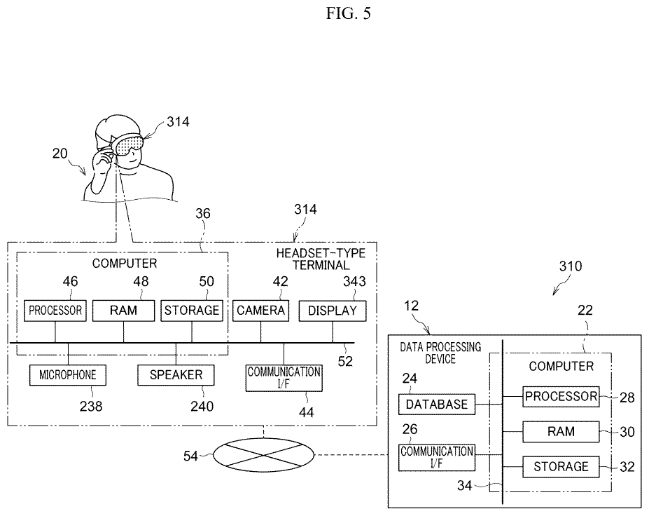

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

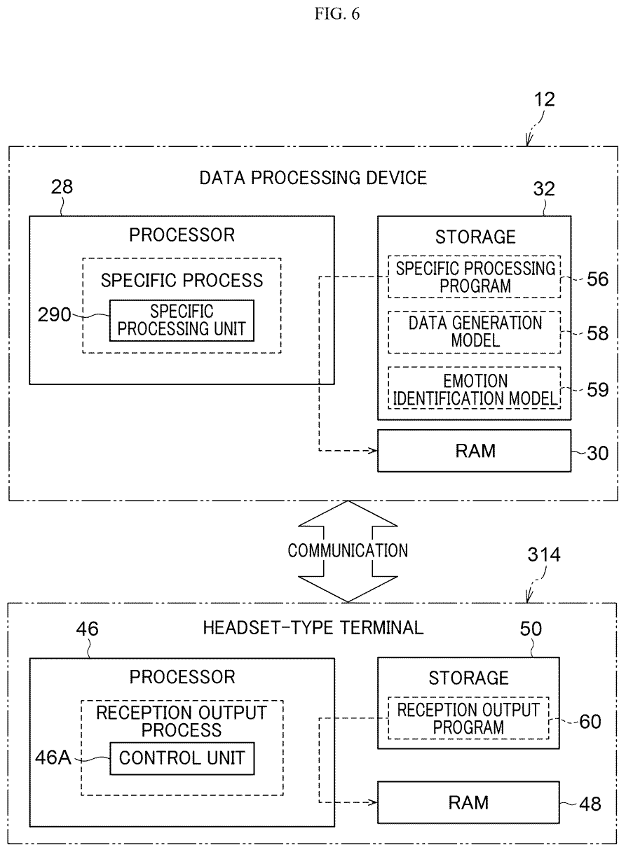

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

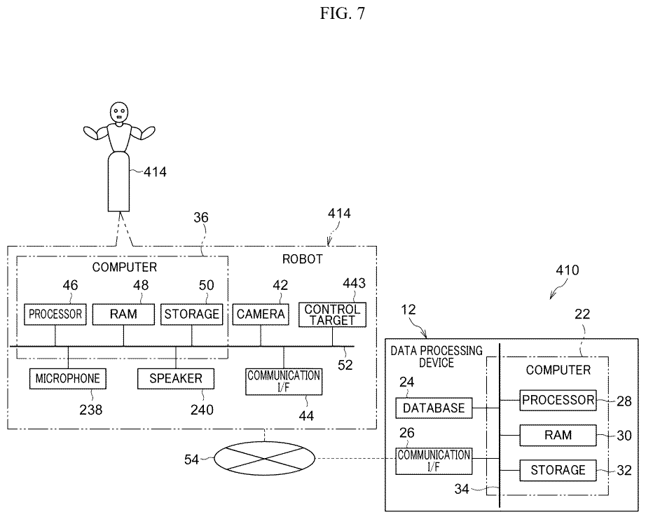

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

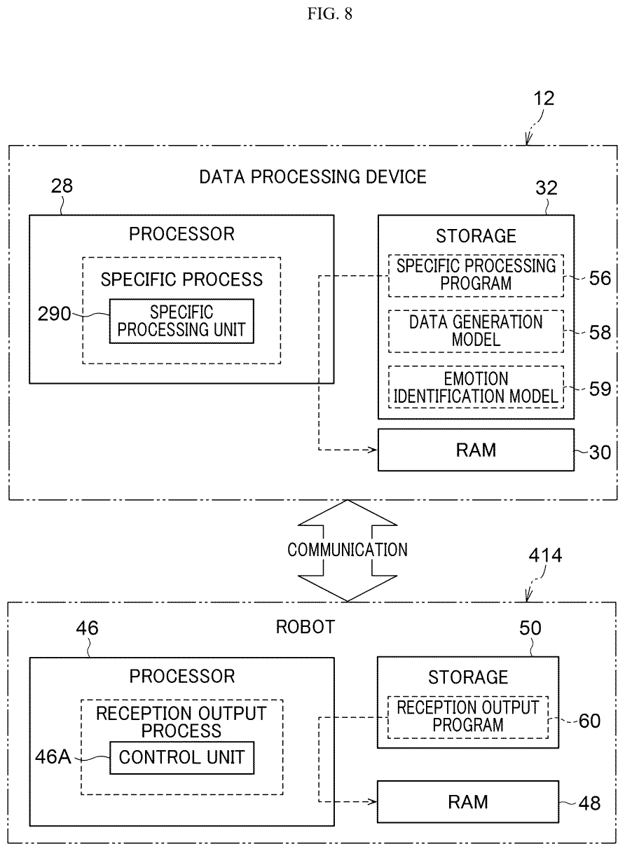

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

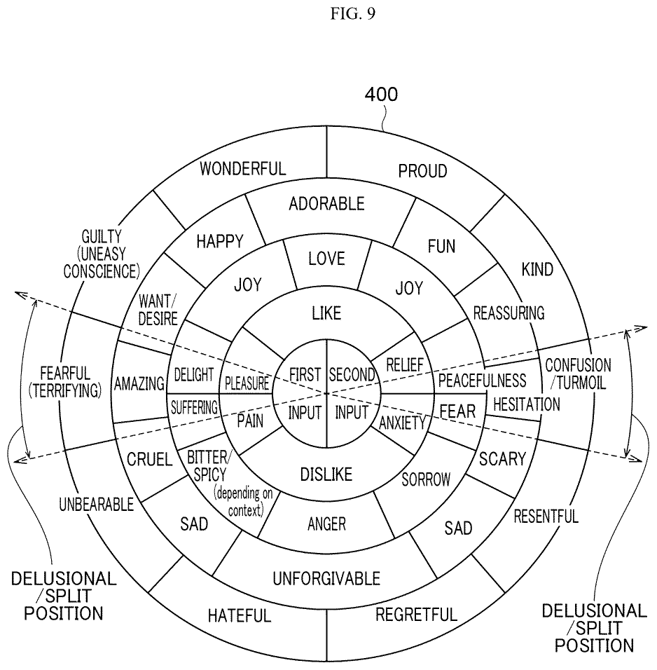

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

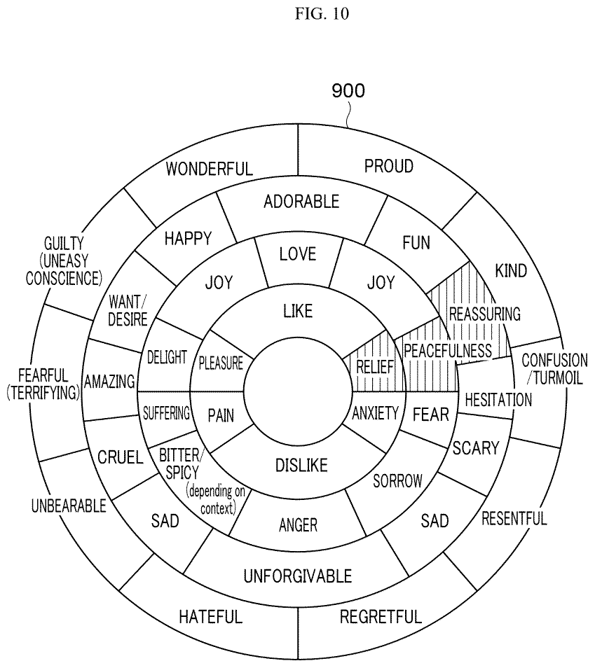

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide, to a terminal, an information input screen for acquiring preference information, body size information, price condition information, and season condition information of a user, and receive, from the terminal, user attribute information including the preference information, the body size information, the price condition information, and the season condition information,
use a numerical computation program and a tabular data processing program to process stored information including clothing item information, and, on the basis of the user attribute information and the stored information, extract and sort the clothing item information so as to generate candidate clothing information suitable for the user attribute information,
generate, on the basis of the user attribute information, the candidate clothing information, and past usage history information, a prompt sentence describing in a natural language the user attribute information and the candidate clothing information, and input the prompt sentence to a generative AI model so as to cause the generative AI model to generate clothing proposal information,
associate clothing configuration information included in the clothing proposal information with the candidate clothing information to create structured recommendation information, and transmit the structured recommendation information and the clothing proposal information to the terminal, and
upload, to an information sharing communication network, try-on visual display information generated on the basis of the clothing configuration information.

### (Supplementary 2)

The system according to supplementary 1,
wherein the processor is configured to
provide, to the terminal, an evaluation input screen for inputting evaluation information with respect to the clothing proposal information and the try-on visual display information, receive, from the terminal, the evaluation information, store the received evaluation information as history information in a storage device, and reuse the history information as the past usage history information for generation of the prompt sentence and extraction of the candidate clothing information.

### (Supplementary 3)

The system according to supplementary 1,
wherein the processor is configured to
generate, on the basis of the user attribute information and vehicle-related item information included in the stored information, a prompt sentence that instructs the generative AI model to generate vehicle modification proposal information, and input the prompt sentence to the generative AI model so as to cause the generative AI model to generate the vehicle modification proposal information.

### Application Example 1

### (Supplementary 1)

A system comprising a processor, a storage device, and a communication interface,
wherein the processor is configured to
receive, via the communication interface, preference information and body dimension information of a user from a user device that includes a display apparatus and an input apparatus for acquiring the preference information and the body dimension information, generate, based on structured information including the preference information and the body dimension information, a prompt sentence that is an instruction described in natural language for proposing garment candidates suitable for the user, by executing character-string generation processing using a generative AI model,
input the prompt sentence and the structured information to a trained inference model, execute feature-extraction processing and similarity-calculation processing by the trained inference model, select the garment candidates suitable for the user from a garment information set, and output attribute information and three-dimensional shape information of the garment candidates,
generate or deform a three-dimensional body model of the user based on the body dimension information, superimpose the garment candidates on the three-dimensional body model based on the three-dimensional shape information by executing three-dimensional rendering processing and shape-fitting processing, and generate a virtual try-on image or virtual try-on three-dimensional scene data,
transmit, via the communication interface, the virtual try-on image or the virtual try-on three-dimensional scene data to the user device for display and upload the virtual try-on image or the virtual try-on three-dimensional scene data to an information-sharing communication network, and
execute, based on merchandise identification information associated with the garment candidates and the virtual try-on image or the virtual try-on three-dimensional scene data, a purchase process in cooperation with a transaction processing apparatus upon receiving a purchase request.

### (Supplementary 2)

The system according to supplementary 1,
wherein the processor is configured to
provide, to the user device, a user interface using the display apparatus and the input apparatus for inputting evaluation information and preference-change information with respect to the virtual try-on image or the virtual try-on three-dimensional scene data, store the evaluation information and the preference-change information in the storage device, and control at least one of the generation processing of the prompt sentence and the selection processing of the garment candidates to be updated based on the stored information.

### (Supplementary 3)

The system according to supplementary 1,
wherein the processor is configured to
acquire, from the user device, specification information and modification-desire information regarding an object different from the preference information and the body dimension information, generate, based on structured information including the specification information and the modification-desire information, a prompt sentence that is an instruction described in natural language for proposing a modification plan of the object by executing character-string generation processing using the generative AI model, and input the prompt sentence to the generative AI model or another trained inference model to output the modification plan of the object.

### Example 2

### (Supplementary 1)

A system comprising a processor and a memory,
wherein the processor is configured to
receive, via an information processing terminal, body dimension data and preference data representing user physical characteristics and user preferences, to convert the received data into structured data, and to cause the structured data to be transmitted through a communication network,
control three-dimensional shape processing software based on the body dimension data to calculate shape parameters for a reference human model, to deform the reference human model according to the shape parameters so as to generate three-dimensional model data representing a body shape of the user, and to store the three-dimensional model data in the memory,
generate intermediate image data by virtually applying clothing data stored in a product information storage to the three-dimensional model data using image processing software or three-dimensional rendering software, the intermediate image data including visual information relating to an application result of the clothing data to the three-dimensional model data,
generate a prompt sentence in a natural language based on the three-dimensional model data, the intermediate image data, the preference data, and product attribute data, the prompt sentence specifying at least a clothing type, a color, a background, a pose, and a display quality, and provide the prompt sentence and the intermediate image data as input data to a generative AI model for image generation,
obtain try-on image data output from the generative AI model corresponding to the prompt sentence, perform at least one of image quality adjustment processing, size compression processing, and additional information superimposition processing on the try-on image data to generate visual feedback data, and cause the visual feedback data to be transmitted to the information processing terminal and uploaded to an information sharing network, and
accept, based on product identification information associated with the visual feedback data, a purchase request from the information processing terminal, execute a purchase process in cooperation with an information processing apparatus that manages inventory information and settlement information, and transmit a result of the purchase process to the information processing terminal.

### (Supplementary 2)

The system according to supplementary 1,
wherein the processor is configured to
cause the visual feedback data to be displayed on the information processing terminal, provide a user interface for receiving evaluation information or opinion information relating to the visual feedback data, store the evaluation information or the opinion information received from the information processing terminal in association with user profile data and product information in the memory, and update at least one of generation conditions of the prompt sentence and proposal conditions of the clothing data based on a storage result.

### (Supplementary 3)

The system according to supplementary 1,
wherein the processor is configured to
obtain, as user input information, modification request data including shape information of an object, decorative requirements, and functional requirements, generate a prompt sentence for causing the generative AI model to generate an appearance modification proposal of the object based on the modification request data, input the prompt sentence to the generative AI model, and obtain image data or three-dimensional model data representing a modification plan of the object.

### Application Example 2

### (Supplementary 1)

A system comprising a processor,
wherein the processor is configured to
acquire preference information and dimension information of a user via a user input/output apparatus that accepts attribute information and body information of the user, and acquire image data of the user via an image sensing apparatus,
execute image processing on the image data to estimate a body shape and body size of the user, and control a three-dimensional shape model generation apparatus based on an estimation result to generate a three-dimensional shape model of the user,
refer to a product information storage area in a storage apparatus using the preference information, the body information, and environment condition information as search conditions, and select clothing candidates based on a suitability score,
construct a prompt sentence for input to a generative information processing model for image generation based on the preference information, the body information, the environment condition information, and the selected clothing candidates,
input the prompt sentence and at least one of the three-dimensional shape model and the image data of the user to the generative information processing model, and cause the generative information processing model to generate a virtual try-on image in which the clothing candidates are virtually worn by the user,
output the virtual try-on image to the user input/output apparatus, and in accordance with an operation of the user, transmit the virtual try-on image to an information sharing communication infrastructure and register the virtual try-on image as publication data, acquire evaluation information regarding the publication data from the information sharing communication infrastructure, and update at least one of a selection rule for the clothing candidates and a construction rule for the prompt sentence for a subsequent processing based on the evaluation information and a selection history of the user, and
cooperate with an electronic transaction processing apparatus to execute a purchase process for clothing corresponding to the virtual try-on image based on an instruction from the user.

### (Supplementary 2)

The system according to supplementary 1,
wherein the processor is configured to
acquire at least one of facial expression information and voice information of the user from the user input/output apparatus, input the at least one of the facial expression information and the voice information to an emotion determination information processing model to estimate an emotional state of the user, and dynamically change at least one of a selection criterion for the clothing candidates and an atmosphere expression in the prompt sentence based on the emotional state so as to cause generation of a virtual try-on image adapted to the emotional state.

### (Supplementary 3)

The system according to supplementary 1,
wherein the processor is configured to
acquire attribute information and customization preference information relating to a movable body of the user, generate a prompt sentence for proposing a change plan of at least one of an appearance and equipment of the movable body based on the attribute information and the customization preference information, and input the prompt sentence to a generative information processing model to cause generation of proposal information or a virtual appearance image relating to the change plan.

What is claimed is:

1. A system comprising:
a communication interface coupled to a packet-switched network; and
circuitry configured to:
provide, to a terminal device via the communication interface, an information input interface for acquiring structured user attribute information comprising preference information, dimensional measurement information, condition parameters, and temporal condition information;
execute numerical computation logic and tabular data processing on stored catalog information in a storage device to extract and sort candidate item information satisfying the user attribute information;
generate a prompt comprising the user attribute information, the candidate item information, and history information in a structured textual format, and input the prompt to a generative neural network model to obtain proposal information;
associate configuration information contained in the proposal information with the candidate item information to create structured recommendation information, and transmit the structured recommendation information to the terminal device via the packet-switched network; and
receive evaluation information from the terminal device and store the evaluation information in the storage device as history information for reuse in subsequent data filtering and prompt generation.

2. The system according to claim 1, wherein the tabular data processing comprises filtering the catalog information based on dimensional range matching, condition parameter matching, and temporal condition matching, and sorting filtered results by a relevance score computed from weighted attribute similarity.

3. The system according to claim 2, wherein the prompt further comprises the history information comprising prior evaluation results and prior proposal selections, and wherein the circuitry generates the prompt by concatenating instruction segments, the user attribute information, the sorted candidate item information, and the history information into a structured template format.

4. The system according to claim 3, wherein the proposal information comprises a ranked list of recommended configurations, each configuration comprising an item identifier, a combination specification, and an explanatory rationale generated by the generative neural network model.

5. The system according to claim 4, wherein the circuitry is further configured to validate each recommended configuration by verifying that the item identifier exists in the catalog information and that the combination specification is compatible with the user attribute information.

6. The system according to claim 1, wherein the circuitry is further configured to generate visual content data by constructing an image-generation prompt comprising the user attribute information, the dimensional measurement information, and appearance parameters of a selected item, and inputting the image-generation prompt to an image generative neural network model to obtain a synthesized image.

7. The system according to claim 6, wherein the image generative neural network model comprises a conditional generative adversarial network or a diffusion model that generates the synthesized image by conditioning on the appearance parameters and the dimensional measurement information.

8. The system according to claim 7, wherein the circuitry is further configured to apply post-processing to the synthesized image comprising resolution scaling, color correction, and background compositing to generate a presentation-ready image.

9. The system according to claim 8, wherein the circuitry is further configured to transmit the synthesized image to the terminal device and to upload the synthesized image to an information sharing network via the packet-switched network in association with metadata comprising the item identifier and a session identifier.

10. The system according to claim 9, wherein the circuitry is further configured to receive opinion information from the terminal device regarding the synthesized image, the opinion information comprising text feedback and a rating value, and to store the opinion information in the storage device in association with the session identifier.

11. The system according to claim 10, wherein the circuitry is further configured to aggregate opinion information received from a plurality of terminal devices via the information sharing network, compute an aggregated feedback score, and incorporate the aggregated score into the history information for subsequent prompt generation.

12. The system according to claim 1, wherein the circuitry is further configured to generate a secondary prompt for instructing the generative neural network model to propose a modification plan for a configurable object based on specification information and modification preference information input by the user, and to input the secondary prompt to the generative neural network model to obtain modification proposal information.

13. The system according to claim 12, wherein the modification proposal information comprises a list of modification elements, each element comprising a component identifier, a modification type, and an estimated parameter change.

14. The system according to claim 1, wherein the circuitry is further configured to perform emotion estimation on text input received from the terminal device to generate emotion state data, and to incorporate the emotion state data into the prompt to adjust recommendation tone and emphasis parameters.

15. The system according to claim 1, wherein the circuitry is further configured to generate a visualization of recommendation trends by aggregating structured recommendation information over a plurality of sessions and computing statistical measures comprising selection frequency per item category and average relevance score per temporal period.

16. The system according to claim 1, wherein the user attribute information comprises body measurement data and style preference data for apparel selection, and wherein the candidate item information comprises apparel catalog entries with size, color, material, and price attributes.

17. The system according to claim 16, wherein the circuitry is further configured to calculate a closed-loop recommendation acceptance rate based on a ratio of selected recommendations to total presented recommendations, and to adjust prompt-generation parameters when the acceptance rate falls below a threshold.

18. A system comprising:
a communication interface coupled to a packet-switched network; and
circuitry configured to:
receive structured user attribute information comprising preference data, dimensional measurement data, condition parameters, and temporal condition data from a terminal device via the communication interface;
execute numerical computation and tabular data processing on catalog information in a storage device to extract candidate item information satisfying the user attribute information, and sort the candidates by a relevance score;
generate a prompt comprising the user attribute information, the sorted candidate item information, and history information including prior evaluation results, and input the prompt to a generative neural network model to obtain proposal information comprising ranked configurations with item identifiers, combination specifications, and explanatory rationales;
generate visual content data by inputting an image-generation prompt comprising user attribute information, dimensional measurement data, and item appearance parameters to an image generative neural network model, and apply post-processing comprising resolution scaling and color correction;
transmit the structured recommendation information and the visual content data to the terminal device, upload the visual content data to an information sharing network, and receive evaluation information and opinion information from the terminal device; and
store the evaluation information and the opinion information as history information for reuse in data filtering and prompt generation.

19. The system according to claim 18, wherein the circuitry is further configured to aggregate opinion information from a plurality of terminal devices via the information sharing network, compute an aggregated feedback score, and incorporate the score into subsequent prompt generation.

20. A method comprising:
receiving, by circuitry coupled to a packet-switched network, structured user attribute information from a terminal device;
executing numerical computation and tabular data processing on stored catalog information to extract and sort candidate item information satisfying the user attribute information;
generating a prompt comprising the user attribute information, the candidate item information, and history information, and inputting the prompt to a generative neural network model to obtain proposal information;
associating configuration information in the proposal information with the candidate item information to create structured recommendation information, and transmitting the recommendation information to the terminal device; and
receiving evaluation information from the terminal device and storing the evaluation information as history information for reuse in subsequent processing.
